(19) United States
(12) Patent Application Publication
(10) Pub. No.: US 2026/0289512 A1
(43) Pub. Date: Sep. 24, 2026

(54) SYSTEM

(71) Applicant: SoftBank Group Corp., Tokyo (JP)

(72) Inventor: Shingo ONO, Tokyo (JP)

(73) Assignee: SoftBank Group Corp., Tokyo (JP)

(21) Appl. No.: 19/567,427

(22) Filed: Mar. 16, 2026

(30) Foreign Application Priority Data
Mar. 19, 2025 (JP) 2025-045115

(51) Int. Cl. G06Q 10/1053; G06F 40/40; G06V 40/16; G10L 25/63

(52) U.S. Cl. CPC G06Q 10/1053; G06F 40/40; G06V 40/174; G10L 25/63

(57) ABSTRACT

A system includes a processor that is configured to create a prompt sentence for instructing a generative artificial intelligence model to generate questions based on a vision and a mission of a company, input the prompt sentence into the generative artificial intelligence model to cause the generative artificial intelligence model to generate questions related to the company vision, and recognize an emotional state of a user from voice and facial expression of the user and adjust a pass or fail determination and a company suitability rate based on the emotional state.

### CROSS-REFERENCE TO RELATED APPLICATION

This application is based on and claims priority under 35 USC 119 from Japanese Patent Application No. 2025-045115 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional interview support systems mainly rely on fixed question sets or manually prepared questions that do not adequately reflect a specific company's vision, mission, strategic priorities, or culture. As a result, it is difficult for such systems to accurately evaluate a candidate's fit with the individual company. Furthermore, existing systems generally do not take into account the candidate's real-time emotional state, such as stress, confidence, or engagement, which can be inferred from voice and facial expressions and which can significantly affect the interpretation of the candidate's answers. Therefore, there is a need for a system that can automatically generate interview questions aligned with a company's vision, mission, strategic thinking, and business insight using a generative artificial intelligence model, and that can also recognize the candidate's emotional state from voice and facial expressions in order to more appropriately adjust a pass or fail determination and a company suitability rate.

### SUMMARY

To solve the above problems, the present invention provides a system comprising a processor, wherein the processor is configured to create a prompt sentence for instructing a generative artificial intelligence model to generate questions based on a vision and a mission of a company, input the prompt sentence into the generative artificial intelligence model to cause the generative artificial intelligence model to generate questions related to the company vision, and recognize an emotional state of a user from voice and facial expression of the user and adjust a pass or fail determination and a company suitability rate based on the emotional state. In some embodiments, the processor is configured to create the prompt sentence for instructing the generative artificial intelligence model to generate the questions based on the vision and the mission of the company. In other embodiments, the processor is configured to create a prompt sentence for instructing the generative artificial intelligence model to generate questions based on strategic thinking and business insight. By combining prompt-based question generation using the generative artificial intelligence model with emotion recognition from voice and facial expressions, the system can automatically generate interview questions tailored to the company's characteristics and can refine the evaluation of the candidate's suitability by adjusting the pass or fail determination and the company suitability rate in accordance with the recognized emotional state.

The term “processor” refers to a hardware component or a combination of hardware and software components that execute instructions to perform data processing, control, and computational operations required by the system.

The term “generative artificial intelligence model” refers to a machine learning model, such as a large language model or other generative model, that is trained on data and configured to generate text, questions, or other content in response to input data or prompts.

The term “prompt sentence” refers to a text string or structured textual input that is provided to the generative artificial intelligence model to instruct the generative artificial intelligence model regarding a content generation task, including conditions or constraints such as generating questions based on a company's vision, mission, strategic thinking, or business insight.

The term “vision of a company” refers to a statement or description that expresses a long-term desired future state, direction, or overarching goal of the company.

The term “mission of a company” refers to a statement or description that expresses the fundamental purpose, role, or main business objectives of the company, including how the company aims to achieve its vision.

The term “questions related to the company vision” refers to questions generated by the generative artificial intelligence model that are at least partially based on the company's vision and that are intended to evaluate a user's understanding of, alignment with, or contribution to the company's long-term goals and direction.

The term “strategic thinking” refers to a way of reasoning that involves long-term planning, evaluation of external and internal factors, assessment of risks and opportunities, and formulation of strategies to achieve business objectives.

The term “business insight” refers to an understanding or perception of business-related factors, such as markets, customers, competitors, financial performance, and operational efficiency, that allows a person to make informed business decisions.

The term “user” refers to an individual who interacts with the system, including but not limited to a job candidate, an interviewer, or a recruiter.

The term “voice” refers to audio data representing speech or other vocal sounds of the user, captured by a microphone or similar input device.

The term “facial expression” refers to visual information representing the user's face, including movements or positions of facial features such as eyes, eyebrows, and mouth, captured by a camera or similar imaging device.

The term “emotional state” refers to an inferred psychological condition of the user, such as stress, confidence, anxiety, engagement, or enthusiasm, estimated based on at least voice and facial expression of the user.

The term “pass or fail determination” refers to an evaluation decision indicating whether the user meets predetermined selection criteria, where “pass” indicates that the user is recommended or accepted and “fail” indicates that the user is not recommended or rejected.

The term “company suitability rate” refers to a numerical value, typically represented as a percentage, indicating a degree of suitability or fit of the user with respect to the company, the company's vision, the company's mission, or the company's culture, as evaluated by the system.

The term “adjust” refers to modifying, correcting, increasing, decreasing, or otherwise changing a value or decision, such as the pass or fail determination or the company suitability rate, based at least in part on the recognized emotional state.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

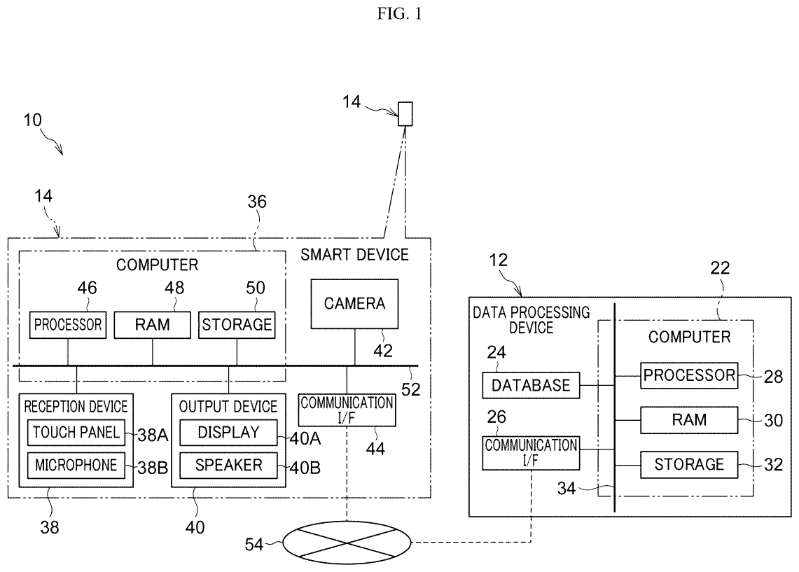

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

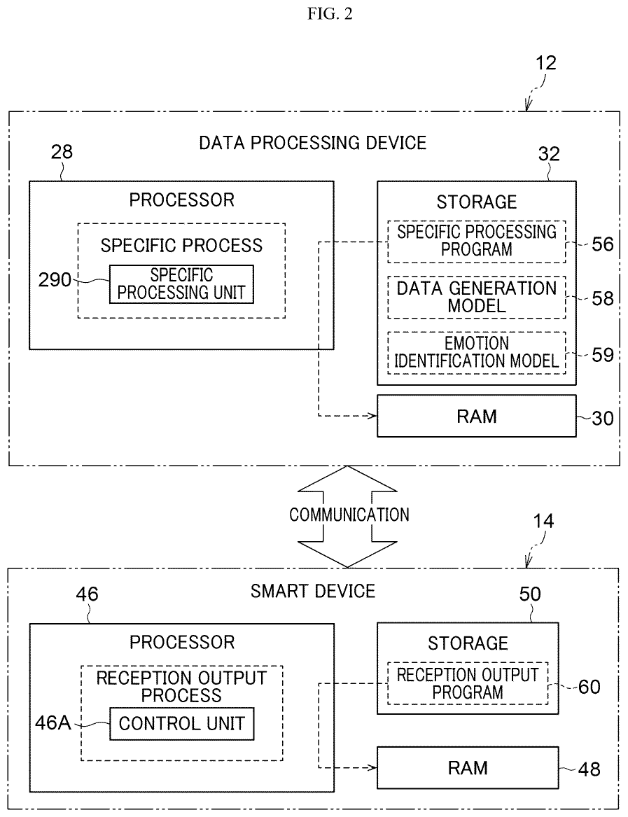

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented interview support systems primarily focus on static questionnaire management and manual scoring, and thus do not fully utilize advances in machine learning and natural language processing. In many systems, an operator must manually design interview questions based on organizational goals or job requirements, which is time-consuming and often inconsistent in quality. Further, even when a generative AI model is used, such use is frequently limited to ad hoc text generation without a structured mechanism to transform organizational goal information into machine-consumable prompt sentences and back into reliably formatted interview questions. As a result, the underlying computing system is not optimized for automatically constructing, executing, and reusing prompt sentences in a way that systematically improves the efficiency and reliability of the overall data-processing pipeline.

In addition, existing systems typically separate question generation, answer collection, and candidate evaluation into loosely coupled or manual processes. Computer resources are not orchestrated to treat these processes as a coherent data flow that begins with structured acquisition of organizational goal information, continues through automatic construction of prompt sentences, and culminates in generation and evaluation of interview data by a generative AI model. This leads to duplicated data processing, non-standardized formats, and increased network and storage overhead, because systems often re-encode or manually reformat information at each stage.

Moreover, prior approaches to candidate evaluation often rely on heuristic rules or simple scoring functions applied to textual answers, without fully integrating additional multimodal information such as voice or facial expressions into a unified computational pipeline. Even when such information is available, it is frequently processed in isolation, and there is no standardized mechanism in the system architecture for combining model-generated evaluation results and recognized emotional state information into machine-computable aptitude determination information. Consequently, the computer system cannot exploit its full processing capability to provide consistent, reproducible aptitude determinations that are tightly coupled with organizational goals.

Furthermore, the lack of a unified architecture for prompt construction and evaluation prompts places substantial cognitive burden on human operators, who must repeatedly design different prompts for different use cases. From a computer-technology standpoint, this results in suboptimal use of generative AI models because the system does not encode domain-specific patterns—such as organizational goal structures and evaluation target capability information—into reusable, machine-generated prompt templates. This prevents the computing system from achieving higher throughput, reduced latency, and improved consistency in interactions with generative AI models.

Accordingly, there is a need for a computer-implemented system that improves the functioning of the computer itself by (i) systematically acquiring and storing organizational goal information and answer information, (ii) automatically constructing structured prompt sentences and evaluation prompt sentences, (iii) tightly integrating generative AI model calls within a controlled data-processing flow, and (iv) combining model-based evaluation results with recognized emotional state information to generate aptitude determination information. Such a system should reduce manual intervention, standardize data formats, and improve the efficiency, reliability, and scalability of the computing environment used for interview question generation and candidate evaluation.

The specific processing by the specific processing unit 290 of the data processing device 12 in Example 1 is realized by the following means.

The present invention provides a server comprising a processor and a storage device, the processor being configured to acquire input information including organizational goal information or job requirement information from a terminal device and store the acquired input information in the storage device, to automatically generate a prompt sentence based on the input information stored in the storage device, the prompt sentence being configured to instruct a generative language model to generate interview questions and including the organizational goal information or the job requirement information and evaluation target capability information, to input the automatically generated prompt sentence into the generative language model, to cause the generative language model to execute natural language processing to generate a plurality of interview question sentences, and to store the generated interview question sentences in the storage device, to transmit the interview question sentences stored in the storage device to the terminal device and cause the terminal device to display the interview question sentences, to acquire answer information of an interviewee from the terminal device and, based on the acquired answer information and at least one of the organizational goal information and the evaluation target capability information, to input an evaluation prompt sentence into the generative language model so as to cause the generative language model to generate an evaluation result of the answer information, and to recognize emotional state information from voice information or facial expression information of the interviewee and calculate aptitude determination information based on the evaluation result and the emotional state information. This enables the computing system to automatically transform structured organizational information into optimized prompt sentences, to systematically control interactions with a generative AI model across question generation and answer evaluation phases, to integrate multimodal emotional state recognition into a unified aptitude determination process, and thereby to improve computer operation by reducing manual data handling, standardizing data formats, and increasing the efficiency, consistency, and scalability of interview-related data processing.

The term “server” refers to an information processing apparatus including at least one processor and at least one storage device, configured to execute programs and communicate with one or more terminal devices via a communication network.

The term “processor” refers to a hardware computation unit, such as a central processing unit or a graphics processing unit, configured to execute instructions of a program to perform data processing, control, and communication operations.

The term “storage device” refers to a non-transitory computer-readable medium, such as a semiconductor memory, magnetic storage, or optical storage, configured to store programs and data including organizational goal information, prompt sentences, interview question sentences, answer information, evaluation results, and aptitude determination information.

The term “terminal device” refers to an information processing apparatus operated by a user, such as a portable terminal, a stationary terminal, or a general-purpose computing device, configured to transmit input information to the server and display information received from the server.

The term “input information” refers to data acquired from the terminal device, including at least organizational goal information or job requirement information, and optionally evaluation target capability information, candidate identification information, and control parameters for question generation and evaluation.

The term “organizational goal information” refers to information representing an objective, policy, vision, mission, or value of an organization, expressed in natural language or structured data, and used as a basis for generating interview questions and evaluating answer information.

The term “job requirement information” refers to information representing requirements, conditions, responsibilities, or desired attributes associated with a job, role, or task, and used as a basis for generating interview questions and evaluating answer information.

The term “evaluation target capability information” refers to information identifying one or more capabilities, competencies, skills, or behavioral characteristics to be evaluated in an interview, such as strategic thinking or teamwork, and used as a condition in constructing prompt sentences and evaluation prompt sentences.

The term “prompt sentence” refers to a natural language sentence or sequence of sentences automatically generated by the processor based on stored input information, the prompt sentence being configured to instruct a generative language model to generate interview question sentences that reflect organizational goal information or job requirement information and evaluation target capability information.

The term “evaluation prompt sentence” refers to a natural language sentence or sequence of sentences automatically generated by the processor, including at least organizational goal information, at least one interview question sentence, and answer information, and being configured to instruct a generative language model to generate an evaluation result of the answer information.

The term “generative language model” refers to a machine learning model, such as a neural network-based natural language model, configured to receive a prompt sentence or an evaluation prompt sentence as input and to output natural language text including interview question sentences or evaluation results.

The term “natural language processing” refers to a computational procedure performed by the generative language model to analyze and generate human language expressions in the form of text based on an input prompt sentence or evaluation prompt sentence.

The term “interview question sentence” refers to a text sequence in natural language generated by the generative language model in response to a prompt sentence, the text sequence being suitable for use as a question posed to an interviewee in an interview context.

The term “answer information” refers to information representing a response of an interviewee to at least one interview question sentence, the response being expressed as text input, transcribed speech, or other machine-readable representation.

The term “evaluation result” refers to information generated by the generative language model based on an evaluation prompt sentence, the information including at least a qualitative or quantitative assessment of the answer information with respect to organizational goal information and evaluation target capability information.

The term “voice information” refers to audio data representing speech of an interviewee, captured by an input device and processed by the server or the terminal device to recognize characteristics such as tone, prosody, or vocal expression.

The term “facial expression information” refers to image or video data representing a face of an interviewee, captured by an imaging device and processed by the server or the terminal device to recognize characteristics such as expressions, movements, or gestures.

The term “emotional state information” refers to information representing an estimated emotional or affective state of an interviewee, derived from voice information and/or facial expression information by an analysis process executed by the processor.

The term “aptitude determination information” refers to information representing a determination or score regarding suitability of an interviewee for an organization or a role, the information being calculated by the processor based on at least an evaluation result and emotional state information.

The term “analyze” refers to a process executed by the processor to perform operations such as parsing, feature extraction, classification, or transformation on input information in order to obtain structured data or parameters used for prompt generation or evaluation.

The term “sentence template” refers to a predefined data structure or pattern of natural language text including variable placeholders, the placeholders being replaced with elements of organizational goal information, job requirement information, or evaluation target capability information to form a specific prompt sentence or evaluation prompt sentence.

The term “number of interview question sentences” refers to a parameter indicating a desired count of interview question sentences to be generated by the generative language model in response to a prompt sentence.

The term “question format” refers to a specification of structural characteristics of interview question sentences, such as open-ended format, closed-ended format, behavioral format, or competency-based format, used by the processor to control the content of a prompt sentence.

The term “organizational suitability” refers to a degree to which answer information aligns with organizational goal information, policies, or values, as determined by the generative language model or the processor based on an evaluation prompt sentence.

The term “capability suitability” refers to a degree to which answer information reflects the evaluation target capability information, as determined by the generative language model or the processor based on an evaluation prompt sentence.

In one embodiment, a server cooperates with one or more terminal devices operated by a user to implement an interview support system based on a generative AI model. The server includes at least one processor and at least one non-transitory storage device. The processor executes software modules that control acquisition of organizational goal information and answer information, automatic generation of a prompt sentence and an evaluation prompt sentence, interaction with a generative AI model, recognition of emotional state information from voice information or facial expression information, and calculation of aptitude determination information.

A server uses general-purpose computing hardware, such as an x86_64-based processor or a graphics processing unit, mounted in a computing platform, such as a rack-mounted server or a virtual machine instance provided by a cloud computing service. A storage device includes a main memory, such as a dynamic random access memory, and a persistent storage, such as a solid-state drive or a magnetic disk. A server executes an operating system, such as a general-purpose server operating system, and an application framework, such as a web framework. A server further executes a database management system, such as a relational database management system or a document-oriented database, to store organizational goal information, job requirement information, evaluation target capability information, prompt sentences, interview question sentences, answer information, evaluation results, emotional state information, and aptitude determination information.

A terminal is implemented as a general-purpose client device, such as a handheld device, a tablet-type device, or a desktop-type device. A terminal includes a display, an input interface such as a keyboard, a touch panel, and a pointing device, a microphone, and an imaging device such as a camera. A terminal executes a client application, such as a web browser or a dedicated native application. A user operates the terminal to input organizational goal information, to view generated interview question sentences, to input or capture answer information, and to review evaluation results and aptitude determination information.

A server defines a specific data structure for input information to improve data management and processing efficiency. Organizational goal information and job requirement information are stored as normalized records including fields such as an identifier, a text field for a vision or mission statement, a text field for job description, and a set of tags representing evaluation target capability information. Evaluation target capability information is represented as a list or vector of capability identifiers, each associated with metadata such as a capability category and a weighting factor. By enforcing structured storage in a database, the server reduces redundant text processing and enables indexed retrieval, thereby improving latency and throughput when constructing prompt sentences and evaluation prompt sentences.

A server uses a generative AI model implemented as a neural network model of the Transformer type. The generative AI model comprises an embedding layer that maps input tokens to continuous vector representations, multiple self-attention layers that compute attention weights over token positions, feed-forward layers, and an output layer that outputs probability distributions over a vocabulary. A server uses a tokenizer, such as a subword-based tokenizer, to convert characters of a prompt sentence into token identifiers. The generative AI model receives a sequence of token identifiers, converts them into embeddings, and propagates them through the Transformer layers, computing context-dependent representations. The generative AI model computes a probability distribution over the next token at each decoding step and generates text by repeatedly selecting tokens according to a sampling strategy controlled by parameters such as temperature and top-p.

A server stores parameters of the generative AI model as weight matrices and bias vectors in the storage device. These parameters are obtained by pre-training the model on a large-scale text corpus using a learning algorithm such as stochastic gradient descent or an adaptive gradient method. During training, a loss function such as cross-entropy loss is computed between predicted token distributions and ground-truth tokens, and gradients are propagated backward through the network to update the weights. A server can further fine-tune the generative AI model on domain-specific texts related to organizational descriptions, interview scripts, and competency frameworks. During fine-tuning, the server augments data by paraphrasing, shuffling sentence orders, and masking certain keywords to improve robustness. As a result, the generative AI model becomes specialized in producing interview question sentences and evaluation text that match patterns of organizational goal information and evaluation target capability information.

A server constructs a prompt sentence using a predefined sentence template and a non-conventional mapping algorithm that is tailored to interview generation. A server retrieves organizational goal information and evaluation target capability information from the database and transforms them into canonical internal representations, such as sets of feature vectors. A server uses these feature vectors to select template segments from a template repository. For example, a server identifies that a capability tagged as “strategic” is associated with a subset of phrase patterns such as “strategic thinking” or “long-term planning,” and a capability tagged as “collaborative” is associated with patterns such as “teamwork” or “cross-functional cooperation.” A server then concatenates selected template segments into a complete prompt sentence.

Examples of prompt sentences generated by the server include: “The company's vision is ‘Realization of a sustainable society’. We want to evaluate the following capabilities: strategic thinking, teamwork. Please generate 5 interview questions that assess the candidate's understanding of sustainability and their ability to apply strategic thinking and teamwork in this context.”

“The company's mission is ‘Empowering local communities through renewable energy solutions’. The target capabilities are project management and stakeholder communication. Please generate 8 behavioral interview questions that evaluate practical experience and decision-making in the context of this mission.”

“The company's vision is ‘Driving digital transformation in the manufacturing industry’. We want to evaluate problem-solving and data-analysis capabilities. Please generate 5 interview questions that require candidates to explain how they would use data and digital tools to improve manufacturing processes, aligned with this vision.”

A server thereby avoids a purely ad hoc usage of the generative AI model. Instead, a server enforces a structured mapping between database records and linguistic components of the prompt sentence. This mapping reduces variance in generated text, improves reproducibility of system behavior, and reduces the need for manual prompt engineering by human operators.

A server also constructs an evaluation prompt sentence in a structured manner. A server retrieves the organizational goal information, at least one interview question sentence, and answer information from the database and assembles them into a specific evaluation prompt format. For example, a server generates an evaluation prompt such as:

“The company's vision is ‘Realization of a sustainable society’. We asked the candidate the following question: ‘What does a sustainable society mean to you in practical terms?’. The candidate answered: ‘I believe a sustainable society is one where environmental impact is minimized while economic development continues through innovation and efficient resource use.’ Please evaluate how well this answer aligns with the vision and with the capabilities strategic thinking and teamwork. Give a score from 1 to 10 and briefly explain the reasons.” A server can also generate evaluation prompts for negative or misaligned answers, for example:

“Company vision: ‘Realization of a sustainable society’. Interview question: ‘How would you balance short-term profit targets with our long-term sustainability goals?’. Candidate's answer: ‘I think we should always prioritize current profits and consider sustainability only when it does not affect margins.’ Please evaluate this answer on a 1-10 scale for alignment with the vision and explain in 3-4 sentences why the answer is appropriate or inappropriate.” A server uses a distinct internal representation for evaluation prompts, which includes fields for organizational goal identifiers, question identifiers, answer identifiers, and numerical parameters specifying required output structure (for example, a score range and explanation length). This representation enables a server to systematically generate evaluation prompts with consistent structure, thereby allowing the generative AI model to produce evaluation results in a predictable format. As a consequence, a server can parse output text more reliably and store numerical scores and explanation segments directly into the database without extensive post-processing.

A server executes additional modules for emotional state recognition. A server receives voice information and facial expression information from the terminal. The terminal captures voice information through a microphone and facial expression information through a camera. The terminal may perform initial encoding, such as compressing audio into a standard format or encoding images into a compressed image format, and transmits the encoded data to the server via a network. Alternatively, the terminal may perform preliminary feature extraction, such as computing mel-frequency cepstral coefficients for audio or extracting facial landmarks using a lightweight model, and send the feature data to the server.

A server analyzes voice information using a signal processing pipeline. A server converts an audio waveform into a time-frequency representation, such as a spectrogram. A server then applies a neural network model for emotion recognition, for example a model that combines convolutional layers for local feature extraction with recurrent layers or Transformer layers for temporal context modeling. The model receives time-frequency features and outputs probabilities over emotional categories, such as “positive,” “neutral,” “negative,” as well as continuous values such as arousal and valence. A server further analyzes facial expression information using a computer vision model, such as a convolutional neural network or a vision Transformer, that receives image patches or video frames and outputs probabilities over facial expression categories, such as “smile,” “frown,” “surprise,” and “confusion.” A server fuses voice-based features and face-based features, for example by concatenating feature vectors and passing them through a fully connected layer, to generate emotional state information that captures multimodal cues.

A server maps emotional state information to numerical indicators, such as stability of affect, congruence with verbal content, and stress level. A server then combines these indicators with evaluation results obtained from the generative AI model. For example, a server adjusts a raw competency score from the generative AI model by increasing the score when emotional state information suggests confident and consistent responses, and decreasing the score when emotional state information suggests high stress or inconsistency. A server calculates aptitude determination information as a structured object including per-capability scores, an overall aptitude score, and explanatory reasons, which may include both textual explanations from the generative AI model and numerical annotations derived from emotional state information.

A server improves computer technology by imposing specific, non-conventional data structures and processing flows. A server does not merely automate human tasks of writing questions or reading answers. Instead, a server introduces a multi-stage pipeline that is specifically designed to optimize interactions with a generative AI model. For example, by storing organizational goal information and evaluation target capability information in a canonical format and using template-based synthesis of prompt sentences, a server reduces the size and complexity of input sequences to the generative AI model. This leads to reduced computational load and network bandwidth usage when the generative AI model is deployed on a separate computing resource. Furthermore, because the server standardizes prompt structure, the generative AI model generates outputs that conform to expected patterns, which reduces the need for expensive downstream text normalization and increases the accuracy of automatic parsing. This improvement in parsing accuracy directly reduces errors in database records and accelerates subsequent processing, because there is less need for human correction.

A server also improves processing speed and scalability by caching intermediate representations. For example, when multiple interview sessions use the same organizational goal information and evaluation target capability information, a server can reuse previously generated prompt sentence components rather than recomputing them. A server stores template fill results and prompt tokenization results so that subsequent calls to the generative AI model can bypass earlier computation stages. This reuse of intermediate data reduces CPU cycles and memory allocation overhead, producing a measurable reduction in response time under heavy load.

A server further introduces non-standard control logic to manage the generative AI model's parameters adaptively. For instance, a server may select different generation parameters such as temperature and maximum token length depending on the complexity of organizational goal information and the number of requested interview question sentences. When organizational goal information is long and complex, a server reduces maximum token length and enforces a concise question pattern to avoid unnecessary verbosity. When organizational goal information is simple, a server increases diversity by adjusting temperature to produce varied question formulations. These dynamic parameter controls are driven by machine-readable features extracted from organizational goal information, rather than by manual tuning, and they optimize computational resource usage and output quality in a way that is specific to interview generation.

In alternative embodiments, a server does not host the generative AI model locally but instead communicates with a remote service via an application programming interface. In such cases, a server still applies the same structured prompt construction and evaluation prompt construction algorithms, but the generative AI model executes on a dedicated inference server or specialized hardware. A server reduces communication load by compressing prompt sentences, batching multiple prompts into single requests, and reusing shared context information across related prompts. By organizing prompts and responses into compressed batches, a server reduces network latency and improves throughput when interacting with high-latency remote AI services.

In another embodiment, a server uses different types of generative AI models for question generation and evaluation. For example, a first generative language model is tuned for generating diverse and context-rich interview question sentences, and a second generative language model is tuned for consistent and calibrated scoring of answer information. A server selects the appropriate model based on task metadata embedded in the prompt sentence or evaluation prompt sentence. This separation allows each model to be optimized with different training data and loss functions, improving overall system accuracy and stability.

A terminal may provide additional technical effects by pre-processing user input to reduce server-side workload. For example, a terminal can perform on-device speech recognition to convert spoken answer information into text using a local speech recognition engine. By transmitting condensed text instead of raw audio, the terminal reduces network usage and offloads part of the computation from the server. Similarly, a terminal can detect basic facial landmarks and send feature coordinates instead of full-resolution images, thereby reducing data volume and protecting privacy while maintaining enough information for emotional state recognition.

A user interacts with the system through graphical user interfaces that guide the user to input structured information. A terminal separates fields for organizational goal information, job requirement information, and evaluation target capability information, and enforces simple validation rules. As a result, data reaching the server is already normalized to some extent, which reduces error conditions and simplifies server-side logic. A user can request generation of additional questions, adjust the number of questions, or specify question formats through the interface, and the terminal transmits these settings as parameters to the server, which then adapts its prompt construction accordingly.

By combining structured database design, specialized prompt construction algorithms, adaptive AI model control, multimodal emotional state recognition, and systematic generation of aptitude determination information, the system provides concrete improvements at the level of computer operation. The server reduces redundant data transformations, improves cache locality, and minimizes network overhead. The server enforces a particular organization of data and a specific flow of information between modules, which in turn leads to reduced processing time, improved accuracy of automatic parsing and evaluation, and lower error rates in stored records. These technical effects go beyond mere automation of human mental steps and demonstrate an improvement in the way the computer system manages, processes, and communicates data in the context of generative AI-based interview support.

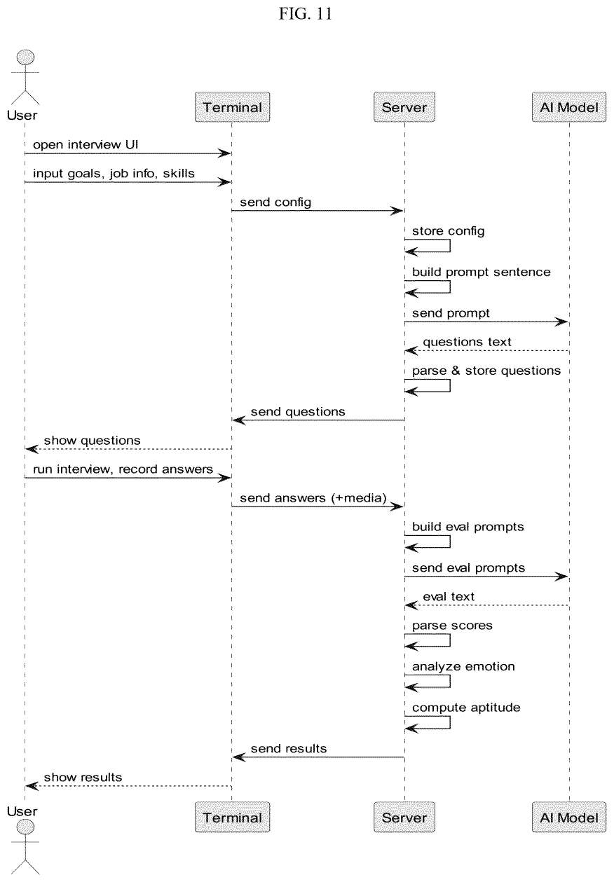

The following describes the processing flow using FIG. 11.

### Step 1

The user operates the terminal to open an interview-setting screen.

The terminal displays input fields for organizational goal information, job requirement information, evaluation target capability information, and generation parameters such as the number of questions and question format.

The user inputs data, for example a vision statement, a mission statement, job description text, and selects capabilities such as strategic thinking and teamwork via check boxes or drop-down lists.

The terminal performs local validation on the input (for example, checks that required fields are not empty, that the number of questions is an integer within an allowable range, and that at least one capability is selected).

The terminal generates a structured data object as input, containing the textual fields and selected capability identifiers.

The terminal outputs this structured data object by serializing it into a request body and transmitting it to the server via a secure communication protocol.

### Step 2

The server receives the structured input from the terminal.

The server parses the request body to extract organizational goal information, job requirement information, evaluation target capability information, and generation parameters.

The server validates the extracted data on the server side, for example ensuring length limits, allowed character sets, and consistency between job requirement information and capabilities.

The server performs a data normalization operation in which it converts free-text fields into canonical forms (such as trimming whitespace, normalizing punctuation, and converting to a standard encoding).

The server assigns or retrieves identifiers for each type of information and constructs internal records that map text fields to capability identifiers and user identifiers.

The server outputs these internal records by storing them in a database, thereby creating persistent interview configuration entries.

### Step 3

The server retrieves the stored interview configuration entries from the database as input for prompt construction.

The server analyzes the organizational goal information and evaluation target capability information using a feature extraction routine, for example by identifying keywords, phrases, and semantic categories associated with each capability.

The server selects sentence template fragments from a template repository based on the extracted features, such as choosing specific phrases associated with long-term orientation when a strategic capability is present.

The server combines the selected template fragments with the actual text of the organizational goal information and capability names to generate a structured prompt sentence.

The server performs string operations to insert the requested number of questions and question format constraints into the prompt sentence.

The server outputs a finalized prompt sentence in natural language that is suitable for input to the generative AI model.

### Step 4

The server receives the finalized prompt sentence as input to an AI interaction module. The server tokenizes the prompt sentence using a tokenizer compatible with the generative AI model, converting characters into token identifiers.

The server constructs a model request object that contains tokenized input, generation parameters such as maximum token length, temperature, and top-p, and any necessary metadata.

The server transmits this model request object to a generative AI model endpoint, either on a local inference server or a remote AI service, using a network protocol.

The server waits for the generative AI model to perform its internal computation and to return generated token sequences corresponding to interview question sentences.

The server outputs the raw AI response, which includes one or more generated token sequences for further processing.

### Step 5

The server receives the raw AI response as input to a post-processing module.

The server converts the generated token sequences into text by applying the inverse of the tokenizer, reconstructing natural language sentences.

The server performs text segmentation to split the generated text into individual interview question sentences, for example by detecting line breaks, numbering patterns, or punctuation boundaries.

The server cleans each question sentence by trimming whitespace, removing numbering artifacts, and standardizing punctuation.

The server associates each question sentence with the corresponding interview configuration identifier and evaluation target capability information, creating structured question records.

The server outputs these structured question records by storing them in the database and preparing them for transmission to the terminal.

### Step 6

The server retrieves the newly stored interview question records as input for delivery to the terminal.

The server constructs a response object that includes question identifiers, question texts, associated capability tags, and configuration identifiers.

The server may filter or sort the questions according to the user's requested number of questions and preferred ordering, applying simple selection or ranking operations.

The server sends the response object to the terminal via a network connection using a structured data format.

The terminal receives the response object and parses it to extract individual question sentences and metadata.

The terminal outputs the question list by rendering it on a display as a scrollable list with interactive controls.

### Step 7

The user views the list of generated interview question sentences on the terminal.

The user may optionally edit, re-order, or deselect some of the questions using controls provided by the terminal, such as text fields or toggle buttons.

The terminal updates the local representation of the question list based on the user's interactions, performing operations such as insertion, deletion, and text modification.

The user confirms the final set of questions to use in the interview.

The terminal outputs the confirmed list of question identifiers and any user edits by sending an update request to the server, allowing the server to synchronize the final question set in the database.

### Step 8

The user conducts an interview by presenting the confirmed question sentences to a candidate.

The terminal displays one question at a time or a subset of questions according to the user's selection.

The user captures answer information by typing text into the terminal or by recording audio using a microphone and/or capturing video using a camera built into the terminal.

If audio or video is captured, the terminal optionally converts the raw streams into a compressed format and may perform on-device speech recognition or facial landmark extraction to obtain intermediate features.

The terminal prepares an answer data object that links each question identifier to corresponding text answers and, when available, to associated audio and video features.

The terminal outputs this answer data object by transmitting it to the server for centralized processing and evaluation.

### Step 9

The server receives the answer data object from the terminal as input to an evaluation module.

The server stores the raw answer information and any audio or video features in the database, associating them with question identifiers, candidate identifiers, and configuration identifiers.

The server retrieves the organizational goal information and evaluation target capability information corresponding to the interview configuration and combines them with each question and corresponding answer to form evaluation input tuples.

For each tuple, the server constructs an evaluation prompt sentence in natural language that includes the organizational goal information, the question sentence, the candidate's answer, and instructions for scoring and explanation format.

The server outputs a sequence of evaluation prompt sentences that are ready to be sent to the generative AI model.

### Step 10

The server receives each evaluation prompt sentence as input to a second AI interaction module.

The server tokenizes each evaluation prompt sentence and packages the tokens into evaluation request objects, setting parameters appropriate for scoring tasks, such as constrained output length and lower temperature to promote deterministic responses.

The server transmits the evaluation request objects to the generative AI model and waits for the model to generate evaluation texts that include numerical scores and explanations.

The server decodes the returned token sequences into evaluation text, parses the evaluation text to extract numerical scores and reasoning statements, and normalizes score values to a defined scale.

The server aggregates per-question scores to produce per-capability scores and an overall score for each candidate.

The server outputs structured evaluation records containing the parsed scores and explanations, and stores them in the database.

### Step 11

The server receives voice information and facial expression information, or their extracted features, as input to an emotional state recognition module.

The server applies signal processing algorithms to the voice information to derive acoustic features, such as pitch contours, energy distributions, and spectral coefficients.

The server applies image processing or computer vision algorithms to facial expression information to extract facial landmarks, expression indicators, and motion vectors.

The server feeds the derived features into one or more trained neural network models for emotion recognition, which output probabilities over emotional categories and continuous values representing affective dimensions.

The server fuses the emotional outputs across modalities and across time segments to produce consolidated emotional state information for each candidate.

The server outputs this emotional state information as structured data linked to the corresponding candidate and interview session in the database.

### Step 12

The server receives the evaluation records and emotional state information as input to an aptitude determination module.

The server applies a rule set or a learned mapping that combines numerical scores from the evaluation records with emotional state indicators, for example by weighting question scores based on emotional stability or adjusting scores when strong negative emotion is detected.

The server computes aptitude determination information, such as a final numerical aptitude score, capability-specific suitability indices, and a summary label such as high fit, medium fit, or low fit.

The server generates additional explanatory text based on the combination of evaluation explanations and emotional indicators, highlighting strengths and weaknesses.

The server stores the aptitude determination information and related summaries in the database, associated with candidate and session identifiers. The server outputs the aptitude determination information to the terminal in a response object for presentation to the user.

### Step 13

The terminal receives the aptitude determination information from the server as input for display.

The terminal parses the response object to extract overall aptitude scores, per-capability scores, emotional indicators, and explanatory text.

The terminal constructs visual representations, such as rating bars, tables, and narrative sections, to present the information in an interpretable form.

The terminal may allow the user to filter or sort candidates based on the computed aptitude scores or specific capability metrics by performing local sorting and filtering operations.

The user reviews the displayed information and uses it to support decision-making, such as selecting candidates for further interviews or offers.

The terminal outputs any user decisions or annotations by optionally sending decision data back to the server for logging and further processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computerized interview support systems generally treat interview questions as static, manually prepared content that is stored and retrieved from a database. Such systems do not adapt the questions in real time to a specific business entity's vision and mission, nor do they technically coordinate large-scale generative artificial intelligence models with terminal-side user interfaces in a structured, programmatic manner. As a result, the generated or selected questions are often misaligned with an organization's long-term strategic objectives and are not optimized to evaluate higher-level capabilities such as executive thinking, strategic thinking, and problem-solving ability.

Furthermore, conventional systems typically do not integrate emotion recognition into the same technical workflow that generates and presents interview questions. Emotion analysis, when present, is often implemented as a separate process that does not feed back into the decision logic for evaluating candidates. This leads to fragmented data processing pipelines in which voice and facial expression data are not systematically combined with question generation results to adjust pass/fail determinations and suitability indices in a technically consistent way.

From a computer-technology perspective, existing systems lack an integrated architecture in which (i) terminal devices capture structured business information, (ii) a server-side processor programmatically constructs precise prompt sentences, (iii) a generative AI model produces question groups aligned with that information, (iv) the results are post-processed into a machine-readable format, and (v) multimodal user interaction data (voice and facial expression) are incorporated into the automated evaluation logic. Without such an architecture, server resources are not efficiently used, API calls to generative AI models are not optimized or controlled in a consistent manner, and the resulting candidate evaluation pipeline remains largely manual and error-prone.

Accordingly, there is a need for an improved computer-implemented technique that automatically transforms organization-specific vision and mission data into dynamically generated, structured interview questions through coordinated prompt construction and interaction with a generative AI model, and that further integrates emotion recognition of a user during the interview to automatically adjust pass/fail determinations and enterprise suitability indices. Such a technique should enhance the technical functioning of the overall interview support system by providing a unified, automated data processing pipeline, more efficient use of generative AI resources, and a consistent linkage between question generation, user interaction, and candidate evaluation.

The specific processing by the specific processing unit 290 of the data processing device 12 in Application Example 1 is realized by the following means.

The present invention provides a server comprising a processor configured to acquire, from an information terminal, character information including at least a business entity vision and a business entity mission, to generate, based on the character information and optional control information including at least one of a number of questions, a difficulty level of the questions, and an evaluation condition indicating a target capability of the questions, a prompt sentence that instructs generation of interview questions, to input the prompt sentence into a generative artificial intelligence model that performs natural language processing so as to cause the generative artificial intelligence model to generate a question group including at least questions related to the business entity vision and the business entity mission, to analyze and format the question group as question data in a predetermined machine-readable format, to transmit the formatted question data to the information terminal and control presentation of the formatted question data as interview questions on a display unit of the information terminal, and to recognize an emotional state based on at least one of voice information and facial expression information of a user during an interview using the presented interview questions and automatically adjust a pass/fail determination and an enterprise suitability index of a candidate based on the emotional state and the generated interview questions. This enables a unified, computer-implemented data processing pipeline in which organization-specific business information entered at the terminal is programmatically converted into dynamically generated, structured interview questions by coordinated server-side prompt construction and interaction with a generative AI model, and in which multimodal emotion recognition results are technically integrated into server-side evaluation logic, thereby improving the technical functioning, efficiency, and consistency of a computerized interview support system.

The term “system” refers to a combination of hardware and software components including at least one server device and at least one terminal device that cooperate to execute the processing described in the claims.

The term “processor” refers to a hardware computation unit, such as a central processing unit (CPU), a microprocessor, or a processing core, that executes instructions stored in a memory to implement the functions specified in the claims.

The term “information processing apparatus” refers to an electronic apparatus including at least one processor, a memory, and communication circuitry, which executes programs to perform data acquisition, prompt sentence generation, interaction with a generative artificial intelligence model, data formatting, and evaluation processing.

The term “information terminal” refers to an electronic user device, such as a mobile communication device, a tablet device, or a personal computing device, having at least a display unit and a communication unit, and configured to transmit and receive data to and from the information processing apparatus and present information to a user.

The term “character information” refers to digital data representing text, including strings of characters, symbols, or numerals, that can be stored, processed, and transmitted by the system.

The term “business entity vision” refers to character information indicating a long-term or overarching objective, goal, or desired future state of an organization, which is used by the system as a basis for generating interview questions.

The term “business entity mission” refers to character information indicating a purpose, role, or fundamental activity of an organization, which is used by the system together with the business entity vision to generate interview questions.

The term “control information” refers to parameter data used by the processor to control behavior of question generation, including at least one of a desired number of questions, a difficulty level of the questions, and an evaluation condition indicating a target capability to be assessed.

The term “prompt sentence” refers to character information generated by the processor that instructs or conditions a generative artificial intelligence model to output interview questions in accordance with the business entity vision, the business entity mission, and optional control information.

The term “generative artificial intelligence model” refers to a software-implemented machine learning model, such as a large-scale neural network configured for natural language processing, that receives a prompt sentence as input and outputs generated text including one or more interview questions.

The term “question group” refers to a collection of one or more questions, represented as text data, that are generated by the generative artificial intelligence model in response to the prompt sentence.

The term “question data” refers to structured or formatted digital data representing the question group in a predetermined machine-readable format suitable for storage, transmission, and display.

The term “predetermined format” refers to a pre-defined data structure or layout, such as a list, array, or marked text format, that is used to represent the generated questions in a consistent and machine-readable manner.

The term “display unit” refers to a hardware display device, such as a liquid crystal display, an organic electroluminescent display, or an equivalent visual output device, provided in the information terminal and configured to visually present question data to a user.

The term “voice information” refers to audio data representing speech produced by a user, which is captured by an audio input device of the information terminal and processed by the system for emotion recognition.

The term “facial expression information” refers to image data or video data representing at least a face region of a user, which is captured by an imaging device of the information terminal and processed by the system for emotion recognition.

The term “emotional state” refers to an internal state of a user, such as satisfaction, dissatisfaction, confidence, anxiety, or neutrality, inferred by the system from at least one of voice information and facial expression information using a computational analysis method.

The term “pass/fail determination” refers to an evaluation result or decision regarding whether a candidate satisfies or does not satisfy a predetermined acceptance criterion in an interview process, as output by the system.

The term “enterprise suitability index” refers to a numerical value or categorical indicator generated by the system that represents a degree of compatibility between a candidate and an organization based on at least the generated interview questions and the recognized emotional state.

The term “executive way of thinking” refers to a pattern of reasoning or decision-making related to high-level management, leadership, and long-term organizational direction, which the system aims to evaluate by the generated questions.

The term “strategic way of thinking” refers to a pattern of reasoning focused on planning, resource allocation, competitive positioning, and long-range objectives, which is targeted by the evaluation questions generated by the system.

The term “problem-solving ability” refers to a capability of identifying, analyzing, and resolving issues or challenges in organizational or business contexts, which the system assesses through the generated questions and subsequent evaluation.

The term “business insight” refers to an understanding of business environments, market conditions, and operational factors, which the system is configured to evaluate using generated questions that require analysis and judgment.

The term “scenario-based questions” refers to questions that present hypothetical or concrete situations and request a candidate to describe actions, decisions, or strategies, thereby enabling evaluation of at least one of executive way of thinking, strategic way of thinking, business insight, and an ability to respond to a challenge.

In one embodiment, a server cooperates with at least one terminal and at least one user to implement the claimed system. The server includes a hardware processor, a memory, a network interface, and non-transitory storage. The terminal includes a hardware processor, a memory, a display unit, an audio input device such as a microphone, an imaging device such as a camera, a network interface, and non-transitory storage. The user operates the terminal to input information and to conduct an interview while viewing questions generated in cooperation with a generative AI model.

The server executes an operating system, such as a general-purpose server operating system, and an application program implementing a question-generation module, a prompt-construction module, a generative AI model interface module, a data-formatting module, and an emotion-based evaluation module. The server stores configuration data, templates for prompt sentences, and logs of generated questions in the memory and in persistent storage.

The terminal executes a client-side application, implemented for example as a native mobile application or a web-based application running in a browser, that provides user interfaces for text input, interview control, and display of generated questions.

The terminal receives character information from the user. The user inputs a business entity vision and a business entity mission as free-form text using a software keyboard displayed on the display unit. The terminal represents this information internally as Unicode character strings and temporarily stores the strings in local storage, such as a key-value store or a local relational database. The terminal associates metadata, such as a timestamp and a user identifier, with the character strings in a structured data record. The terminal transmits the character information to the server through the network interface using a structured message, for example as a serialized object defined by a schema. In this way, the terminal converts human-entered text into digital character information suitable for further automatic processing.

The server receives the character information and stores the received data in a database or an in-memory data structure. The server normalizes the character information by converting it to a uniform character encoding, trimming whitespace, and optionally performing lexical normalization, such as converting full-width characters to half-width characters and standardizing punctuation. The server then maps the normalized character information into an internal representation, for example a record containing fields for “vision”, “mission”, and control attributes.

The server generates a prompt sentence using a prompt-construction module. The server accesses a prompt template stored in the memory and fills placeholders in the template using the normalized vision and mission strings. The server may also incorporate control information received from the terminal, such as the desired number of questions, a difficulty level, and a target capability category. The server concatenates fixed segments of text and variable segments derived from the vision, mission, and control information using string manipulation operations. In one example, the server creates a prompt sentence such as:

“You are an assistant that generates executive-level interview questions.

Company vision: ‘Realizing a sustainable society through renewable energy and circular economy practices.’

Company mission: ‘Providing scalable and affordable solutions to support that vision.’ Based on the above, generate 5 open-ended interview questions that evaluate a candidate's strategic thinking and problem-solving ability. Avoid yes/no questions and focus on long-term, vision-driven decision-making.”

In another example, the server creates a prompt sentence such as:

“You are an AI specialized in creating interview questions. Company mission: ‘To deliver cutting-edge digital solutions that empower small and medium-sized enterprises to thrive globally.’

Generate 5 interview questions that assess executive thinking, including market analysis, competitive strategy, and long-term value creation for small and medium-sized enterprises. Each question should be clear and suitable for a senior leadership interview.”

The server uses a generative AI model interface module to transmit the prompt sentence to a generative AI model. The generative AI model is implemented as a neural network model trained for natural language processing, for example a transformer-based architecture with multiple encoder-decoder or decoder-only layers, attention mechanisms, and learned token embeddings. The generative AI model has been pre-trained on large corpora of text and fine-tuned to generate coherent, context-sensitive question text in response to prompt sentences.

The server represents the prompt sentence as a sequence of tokens using a tokenizer associated with the generative AI model, such as a byte-pair encoding tokenizer, and sends the token sequence and control parameters such as temperature and maximum output length to the generative AI model through an application programming interface.

The generative AI model processes the token sequence internally by computing multi-head self-attention over the token embeddings, applying feed-forward layers, and performing normalization and activation functions in each layer. The generative AI model computes probability distributions over possible next tokens at each generation step, conditioned on the prompt sentence. The generative AI model selects output tokens according to the probability distribution, using sampling strategies such as top-k sampling, nucleus sampling, or greedy decoding, to generate text that comprises an ordered list of questions. The generative AI model returns the generated tokens to the server, and the server decodes the tokens back into character strings.

The server reformats the generated text using the data-formatting module. The server parses the text into discrete questions, for example by splitting on newline characters, by recognizing numeric prefixes such as “1.” or “Q1:”, or by applying a regular expression that identifies question delimiters. The server stores the resulting collection of questions in a structured data format, such as an array of strings with associated indexes. The server may assign identifiers to each question to facilitate tracking and feedback. This formatting operation converts an unstructured output stream from the generative AI model into machine-readable question data that can be efficiently transmitted, stored, and re-used.

The server transmits the formatted question data to the terminal. The server uses the network interface to send a structured message that contains the array of questions along with metadata such as the associated vision, mission, language, and generation parameters. The terminal receives the structured message, decodes it according to the predefined schema, and extracts the list of questions. The terminal then renders the questions on the display unit. The terminal uses a list-based graphical component to display each question with a consistent layout, such as a numbered list. The terminal may allow the user to scroll, select, or tag questions, and to switch between different sets of questions corresponding to different vision and mission pairs.

The user conducts an interview while viewing the questions on the terminal. The user may ask the questions to a candidate and optional additional questions. While the interview is ongoing, the terminal captures voice information and facial expression information related to the user or candidate. The terminal uses the microphone to acquire audio signals and digitizes the audio into time-series data with a sampling frequency suitable for speech analysis. The terminal uses the camera to capture images or video frames that include a face region. The terminal may pre-process the audio to extract features such as Mel-frequency cepstral coefficients, pitch, energy, and spectral features, and may pre-process the images or video frames to crop and normalize the face region using a face detection algorithm.

The server receives the pre-processed voice information and facial expression information from the terminal and performs emotion recognition using the emotion-based evaluation module. The server uses one or more neural network models, for example a convolutional neural network for facial expression classification and a recurrent neural network or transformer model for speech emotion recognition, to map the input features into an emotional state. The server defines output categories such as positive, neutral, negative, confident, and anxious, and assigns numerical scores or probabilities to each category. The server may fuse the outputs from audio-based and image-based models using a weighted average or a learned fusion network to obtain a combined emotional state representation.

The server associates the emotional state representation with the generated questions and the candidate record. The server adjusts a pass/fail determination and an enterprise suitability index for the candidate based on the emotional state and the content of the questions. The server may apply predefined rules, such as increasing a suitability index if the emotional state indicates confidence and engagement in response to vision-aligned questions, or decreasing the index if the emotional state indicates strong negative reactions to core mission-related topics. The server may also use a machine learning model trained to map features of the emotional state, question categories, and candidate responses into a numerical suitability index. The server stores the resulting pass/fail determination and suitability index in a database.

The server thereby implements a technical pipeline that coordinates the generative AI model, question formatting, communication with the terminal, and multimodal emotion recognition into a unified sequence of machine-level operations. This architecture improves computer technology in several respects. By dynamically constructing prompt sentences from structured vision and mission data and control parameters, the server reduces redundant or inefficient requests to the generative AI model, which can reduce communication load and processing time. By formatting the output of the generative AI model into a consistent machine-readable structure, the server improves data management, enabling efficient indexing, retrieval, and reuse of question sets. By incorporating multimodal emotion recognition into the evaluation pipeline, the server enables automatic adjustment of decision-related metrics based on signals that are computationally derived rather than manually interpreted, which can enhance consistency and reduce human bias.

The server uses non-conventional rules to construct prompt sentences and to interpret the generative AI model output. For example, the server groups vision and mission text into semantic categories and encodes these categories as explicit instructions in the prompt sentence, such as “focus on long-term sustainability trade-offs” or “assess ability to handle ambiguous global expansion scenarios.” The server thereby shifts part of the semantic analysis to an explicit control layer that structures the prompt in a way that is optimized for efficient question generation by the generative AI model. This explicit control layer is different from conventional manual question writing or simple template substitution because it programmatically manipulates higher-level semantic instructions based on a machine-tractable representation of organizational goals.

The generative AI model used by the server is, in one embodiment, trained with supervised learning and reinforcement learning, and the server may be configured to fine-tune or select a particular model variant based on historical performance. The training process uses a loss function such as cross-entropy between predicted tokens and reference tokens, and the model parameters are updated using a gradient-based optimizer. Data augmentation techniques, such as paraphrasing of training questions and augmentation of context descriptions, can be used to improve robustness. Internal attention weights in the generative AI model emphasize segments of the prompt sentence that correspond to the vision and mission, thereby improving the alignment of generated questions with the specific organization. The server can support multiple alternative embodiments. In one embodiment, the generative AI model executes on the same physical server as the prompt-construction module. In another embodiment, the generative AI model executes on a separate computing system connected via a network. In a further embodiment, the server selects among multiple generative AI models with different sizes or capabilities based on a latency constraint or a cost constraint. The terminal may be a mobile device, a desktop computer, or a head-mounted display, and may use different operating systems and graphical frameworks. The emotion recognition module may reside entirely on the server or be distributed between the terminal and the server to reduce communication load by performing feature extraction locally on the terminal.

The system is not limited to any particular type of organization, industry, or interview scenario. The server can use different prompt templates for executive-level interviews, technical interviews, or leadership potential assessments. The server can also adapt control information based on feedback from the user, such as marking certain generated questions as effective or ineffective. The server analyzes this feedback and updates weighting factors that influence future prompt sentence construction, thereby gradually optimizing question generation in a data-driven manner. This feedback loop operates at the level of machine-readable parameters, rather than simply recording human judgments, and thus contributes to ongoing technical improvement of the system's behavior.

By implementing these modules and data flows, the server, the terminal, and the user cooperate in a way that goes beyond simple automation of human question writing. The server programmatically constructs prompt sentences from structured organizational data, coordinates with a generative AI model that uses a complex, multi-layer neural architecture, converts unstructured generated text into structured question data, and integrates multimodal emotion recognition into the evaluation logic. The resulting system improves processing speed by automating tasks that would otherwise require manual review and adaptation of questions, improves precision by aligning generated questions with precise semantic interpretations of the vision and mission, and improves data management by enforcing standardized data formats and evaluation indices. These technical effects arise from the specific configuration and interaction of the server, the terminal, and the generative AI model, and thus support concrete embodiments of the claimed invention.

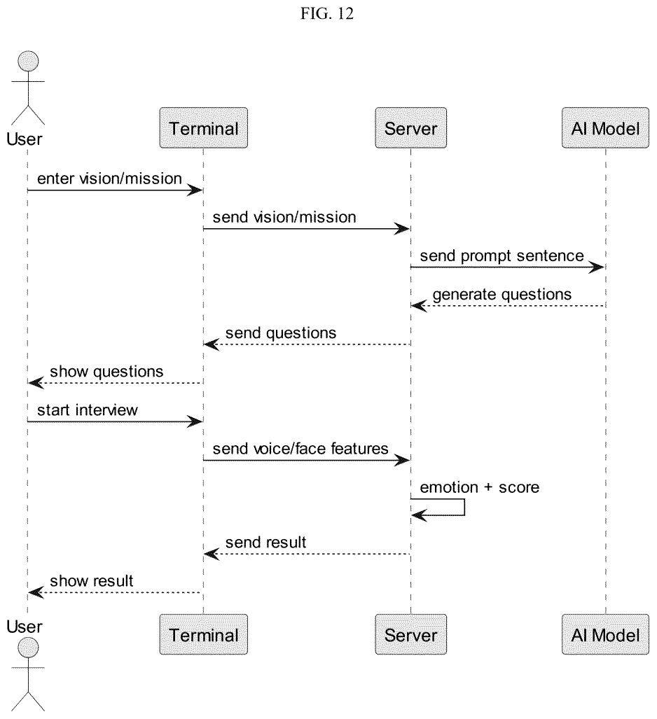

The following describes the processing flow using FIG. 12.

### Step 1

The terminal displays an input screen for business information.

The terminal initializes a user interface including text input fields for a business entity vision and a business entity mission, and optionally controls such as dropdowns or sliders for a desired number of questions and difficulty level. The terminal receives character input from the user via a software keyboard and stores the raw input as Unicode strings in a temporary memory buffer.

Input: User keystrokes and touch events.

Processing: The terminal converts the keystrokes into character codes, aggregates them into strings, and associates them with logical fields (“vision”, “mission”, and control parameters).

The terminal validates that the strings are non-empty and within a predefined length range, and trims leading and trailing whitespace.

Output: Validated and normalized character strings representing the vision and mission, plus control parameter values, stored in a structured record in the terminal memory.

### Step 2

The terminal transmits structured business information to the server.

The terminal constructs a structured message containing the vision string, the mission string, and any control parameters such as question count and difficulty level. The terminal serializes this structured data according to a predefined schema and sends it to the server via a network interface.

Input: Structured record containing normalized vision text, mission text, and control parameters.

Processing: The terminal encodes the record into a transmission format, assigns a unique request identifier, and selects a communication protocol (for example, HTTPS over TCP/IP).

The terminal opens a network connection to the server, writes the serialized payload into the connection buffer, and manages retransmission in case of temporary communication errors.

Output: A network request message delivered to the server containing the business information and control parameters.

### Step 3

The server receives and stores the business information.

The server listens on a network port for incoming requests and, upon reception, decodes the structured message into internal data objects. The server writes the vision text, mission text, control parameters, and a timestamp into server-side memory and optionally into persistent storage for logging or audit purposes.

Input: Network request message including serialized vision, mission, and control parameters.

Processing: The server uses a communication stack to parse protocol headers and extract the message body, then uses a deserialization routine to reconstruct objects representing the business information. The server performs normalization by enforcing a uniform text encoding, trimming whitespace, and rejecting invalid characters according to a character whitelist.

Output: Normalized internal data objects representing the business entity vision, mission, and control parameters, accessible to subsequent modules in server memory.

### Step 4

The server constructs an internal semantic representation of the business information.

The server analyzes the vision and mission strings to identify semantic categories such as “sustainability,” “global expansion,” or “digital transformation.” The server uses a keyword list, pattern-matching rules, or a lightweight natural language processing module to classify and annotate the text with semantic tags.

Input: Normalized vision and mission strings.

Processing: The server tokenizes the text into words or subwords, compares the tokens to a stored list of domain-relevant terms, and assigns category labels when token patterns match the list or rules. The server may compute a vector representation of the text using a word embedding or sentence embedding model to identify similarity to known category vectors and then assign the most similar categories.

Output: A semantic representation that includes the original vision and mission strings plus category labels and embedding vectors stored in an internal data structure.

### Step 5

The server generates a prompt sentence for a generative AI model.

The server loads a prompt template from configuration storage and fills placeholders with the original strings and semantic annotations. The server uses logic that selects specific instruction phrases depending on the semantic categories and control parameters.

Input: Semantic representation including vision, mission, categories, and control parameters.

Processing: The server chooses a base template (for example, an “executive-level interview” template) and inserts the vision and mission into designated text positions. The server appends detailed instructions, such as “focus on long-term sustainability trade-offs” or “assess ability to manage global expansion under resource constraints,” when corresponding categories are present. The server also inserts the requested number of questions and difficulty level by converting numeric parameters into text like “generate 5 difficult, open-ended questions.”

Output: A fully composed prompt sentence in natural language, ready to be transmitted to the generative AI model.

### Step 6

The server transmits the prompt sentence to the generative AI model.

The server accesses an application programming interface for the generative AI model and encodes the prompt sentence according to that interface's input format. The server converts the prompt sentence into a token sequence using a tokenizer associated with the generative AI model and includes additional parameters such as temperature and maximum output length.

Input: Prompt sentence generated in natural language and control parameters for generation behavior.

Processing: The server invokes an API client routine that performs tokenization, packages the token sequence and parameters into a structured payload, and sends the payload to the generative AI model endpoint over a network. The server manages authentication information and enforces rate limits by queuing or delaying requests when necessary.

Output: A request to the generative AI model containing an encoded prompt sentence and generation parameters.

### Step 7

The generative AI model generates a question group.

The generative AI model receives the tokenized prompt and processes it through a transformer-based neural network consisting of multiple attention layers and feed-forward layers. The model computes hidden representations for each token and calculates probability distributions over possible next tokens.

Input: Token sequence representing the prompt sentence and model parameters such as temperature and maximum tokens.

Processing: The generative AI model applies multi-head self-attention to compute contextualized embeddings, feeds these embeddings through nonlinear layers with normalization and residual connections, and iteratively predicts subsequent tokens by sampling from the probability distributions at each time step. The model uses a decoding algorithm such as greedy decoding, top-k sampling, or nucleus sampling to generate a sequence of tokens that form interview questions.

Output: A generated token sequence representing multiple interview questions, returned to the server in a structured response.

### Step 8

The server decodes and structures the generated questions.

The server receives the token sequence from the generative AI model and decodes the tokens into a character string. The server then splits the string into individual questions and structures them in a data format that includes indexes and metadata.

Input: Token sequence or encoded text output from the generative AI model.

Processing: The server uses the same tokenizer in reverse (detokenization) to convert token IDs back into characters. The server identifies question boundaries by detecting delimiters such as line breaks, numbering patterns (“1.”, “2.”), or question marks at the end of sentences. The server trims whitespace, removes duplicate numbering if necessary, and constructs an array or list in which each element corresponds to one question, optionally tagging each question with derived attributes such as length or keyword presence.

Output: A structured question group represented as an array of question strings with associated metadata.

### Step 9

The server formats question data for transmission to the terminal.

The server packages the array of questions and associated metadata into a structured message.

The server ensures that the questions are tagged with identifiers that link them to the originating vision and mission, and with generation parameters used in the current session.

Input: Structured question group and associated metadata.

Processing: The server converts the internal data structure into a serialization format defined by a schema, attaches a unique session ID and question IDs, and includes any additional fields needed by the terminal, such as preferred display order. The server checks the size of the message and, if necessary, truncates or compresses certain fields to meet communication constraints.

Output: A serialized question data message ready for transmission to the terminal.

### Step 10

The server sends the question data to the terminal.

The server transmits the serialized message over the network to the terminal that initiated the request. The server sets appropriate protocol headers and a success status code and may log the transaction for monitoring and debugging.

Input: Serialized question data message prepared by the server.

Processing: The server writes the message to the communication socket associated with the terminal connection, handles low-level retransmission or error correction as needed, and updates internal logs with the size and timing of the data transfer.

Output: A network response containing the question data delivered to the terminal.

### Step 11

The terminal receives and parses the question data.

The terminal monitors its network interface for responses from the server and, upon receiving a message, decodes it into a structured object representing the question group.

Input: Network response from the server containing serialized question data.

Processing: The terminal uses a deserialization routine aligned with the server's schema to reconstruct an array or list of questions and associated metadata. The terminal verifies the integrity of the message using checksums or sequence numbers when available, and discards or requests retransmission in case of data corruption.

Output: An internal data structure on the terminal containing the ordered list of questions and related attributes.

### Step 12

The terminal presents the questions to the user.

The terminal updates the user interface to show the question list on the display unit. The terminal formats each question with numbering and style parameters, and may allow the user to scroll, tap, or mark questions.

Input: Internal question list and metadata stored on the terminal.

Processing: The terminal binds the question data to a visual list component, applies fonts, margins, and colors defined by the user interface design, and maps each question string to a visual element with an index label such as “Q1,” “Q2,” and so on. The terminal adjusts layout based on screen size and orientation and may pre-render off-screen items for smooth scrolling.

Output: A visually rendered list of interview questions displayed on the terminal screen for the user.

### Step 13

The user conducts an interview using the displayed questions.

The user reads the questions from the display unit and asks them to a candidate. The user may select or skip certain questions based on the interview progress.

Input: Displayed question list and user interaction with the terminal interface.

Processing: The user interprets the question content and utilizes the terminal as a reference; the terminal records simple interaction events such as which questions are opened, marked, or skipped. These events may be stored as interaction logs for later analysis.

Output: Human-delivered interview questions guided by the generated list and a log of user interactions on the terminal.

### Step 14

The terminal captures voice information and facial expression information during the interview.

The terminal activates the microphone and camera during the interview session, upon explicit user consent, to record audio and visual data associated with the user and/or the candidate.

Input: Acoustic signals from the environment and light signals captured by the camera sensor.

Processing: The terminal samples the microphone input at a fixed sampling rate and converts analog signals into digital audio frames. The terminal captures image frames or video at a defined frame rate and resolution. The terminal may perform on-device pre-processing, such as noise reduction and automatic gain control for audio, and face detection and cropping for visual frames. The terminal extracts features such as Mel-frequency cepstral coefficients, pitch contours, and energy features from the audio, and geometric or appearance-based features (such as facial landmarks or convolutional feature maps) from the images.

Output: Pre-processed voice feature sequences and facial expression feature sequences stored in a structured format on the terminal.

### Step 15

The terminal transmits emotion-related features to the server.

The terminal packages the extracted audio and visual features into structured messages and sends them to the server for emotion recognition.

Input: Voice and facial expression feature data computed on the terminal.

Processing: The terminal groups features into time windows aligned with interview segments or with specific questions. The terminal assigns timestamps and identifiers linking each feature segment to the relevant question or interview phase. The terminal serializes the feature data, compresses it if necessary to reduce bandwidth consumption, and sends it to the server using a communication protocol with appropriate security measures.

Output: Network messages containing structured emotion-related feature data delivered to the server.

### Step 16

The server recognizes the emotional state from the received features.

The server receives the audio and visual feature data and applies one or more trained neural network models to infer an emotional state.

Input: Structured feature sequences for voice and facial expression, with timestamps and question identifiers.

Processing: The server inputs the voice features into a model such as a recurrent neural network, a transformer-based sequence model, or a temporal convolutional network that is trained to classify emotional categories. The server inputs the facial features into a convolutional network or a hybrid network trained on facial expression datasets. The server obtains probability distributions over emotional labels from each model and fuses them by applying a weighted sum or a learned fusion layer. The server computes a final emotional state vector representing the likelihood of various states such as positive, neutral, or negative, and confidence or anxiety.

Output: An emotional state representation associated with specific questions and time segments, stored in an evaluation data structure on the server.

### Step 17

The server adjusts a pass/fail determination and enterprise suitability index.

The server combines the emotional state representation with the question metadata and candidate information to compute an updated evaluation of the candidate.

Input: Emotional state representation, question group metadata, and candidate record data.

Processing: The server applies an evaluation algorithm that calculates a suitability index as a function of emotional state scores, question categories, and optionally historical data about successful candidates. The server may apply a regression model, a decision tree model, or a rule-based system that increases or decreases the index when particular emotional patterns occur in response to mission- or vision-critical questions. The server compares the resulting suitability index with a threshold to determine a pass or fail status and may adjust this threshold based on organization-specific parameters.

Output: An updated pass/fail flag and enterprise suitability index stored in the candidate's evaluation record on the server.

### Step 18

The server optionally transmits evaluation results back to the terminal.

The server prepares a summary of the candidate's evaluation, including the pass/fail determination, the suitability index, and optionally a breakdown by question or emotional state. The server sends this summary to the terminal for display to the user.

Input: Candidate evaluation record containing computed metrics and status.

Processing: The server serializes the evaluation results into a structured message that may include numeric scores and brief textual explanations, such as “strong alignment with sustainability vision” or “moderate anxiety in response to global expansion questions.” The server sends this message to the terminal using the same secure communication channel used for question data.

Output: An evaluation summary message delivered to the terminal.

### Step 19

The terminal displays the evaluation summary to the user.

The terminal receives the evaluation summary and presents it to the user in a clear, structured format.

Input: Network message containing evaluation results from the server.

Processing: The terminal parses the message, extracts the pass/fail status, suitability index, and any textual comments, and maps them to user interface elements such as labels, charts, or progress bars. The terminal may allow the user to navigate between different sections, such as overall score and per-question emotional response summaries.

Output: A visual display of the candidate evaluation on the terminal, enabling the user to understand the results and make informed decisions based on the generated questions and recognized emotional states.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional interview evaluation systems that utilize computing devices suffer from several technical shortcomings when processing unstructured interview text data and aligning it with organization value information. First, raw interview text, which includes free-form applicant responses and evaluator comments, is typically stored and processed as undifferentiated character sequences. This leads to inefficient use of processing resources because the system must repeatedly handle large amounts of unstructured data without leveraging structured linguistic features, resulting in increased latency and processor load when performing evaluation.

Second, when a generative AI model is used, conventional systems tend to pass raw or minimally processed text directly to the model without a well-structured prompt sentence that explicitly encodes evaluation objectives and output constraints. As a result, the generative AI model frequently produces outputs that are inconsistent in format, omit necessary fields such as a numerical suitability rate, or include ambiguous language that must be manually interpreted. This degrades the reliability and reproducibility of the machine-based evaluation and can require additional parsing operations that further burden computational resources.

Third, conventional systems do not integrate a dedicated processing flow in which interview result information and organization value information are systematically transformed into analyzable feature data and then into a machine-interpretable prompt sentence that guides the generative AI model to generate structured analysis result information. The absence of this integrated flow prevents the system from effectively constraining the behavior of the generative AI model, leading to variability in results and difficulties in automatically extracting a pass/fail decision and suitability rate.

Fourth, conventional approaches often lack a mechanism for applying predetermined correction criteria to suitability rates computed by the generative AI model, such as normalizing scores across different interview sets or enforcing minimum policy thresholds.

Without such mechanisms, the generated suitability rates may not be directly comparable or actionable across multiple applicants, which complicates automated decision-making processes and can require manual recalibration.

Accordingly, there is a need for a computer-implemented system that improves the way interview result information is preprocessed, transformed into feature data, embedded into a structured prompt sentence, and provided to a generative AI model, such that the resulting analysis is produced in a consistent, machine-parseable format. There is also a need for the system to correct and standardize the suitability rate based on predetermined criteria, thereby improving the technical performance and reliability of automated interview evaluation on computing hardware.

The specific processing by the specific processing unit 290 of the data processing device 12 in Example 2 is realized by the following means.

The present invention provides a server comprising a processor configured to receive interview result information including applicant response information from a terminal and store the interview result information as record data in a storage device; preprocess character information included in the interview result information by using a natural language processing technique to generate analyzable feature data by performing at least morphological analysis, word segmentation, removal of non-informative terms, and normalization of word forms; generate a prompt sentence that uses the feature data and organization value information as inputs and instructs a generative AI model to evaluate a degree of suitability of the applicant with respect to the organization value information; input the prompt sentence to the generative AI model to cause the generative AI model to generate analysis result information including a pass/fail decision and a suitability rate; extract the suitability rate and pass/fail information from the analysis result information; correct the suitability rate based on a predetermined criterion; generate output data including a corrected suitability rate and the pass/fail information for the terminal; and transmit the output data to the terminal to cause the terminal to display the corrected suitability rate and the pass/fail information. This enables the computing system to transform unstructured interview text into structured linguistic feature data, to constrain a generative AI model via a machine-designed prompt sentence so that the model outputs standardized and machine-parseable evaluation results, and to normalize and present suitability metrics in a consistent manner, thereby improving the reliability, efficiency, and technical performance of computer-implemented interview evaluation.

The term “interview result information” refers to electronic data representing content of an interview, including at least applicant responses, interviewer comments, and associated context information acquired during an interview process.

The term “applicant response information” refers to text or other machine-readable data that expresses answers, statements, or explanations provided by a candidate in response to interview questions.

The term “terminal” refers to an information processing apparatus, such as a client device, that is configured to transmit interview result information to a server and to receive and display evaluation results from the server.

The term “record data” refers to structured or semi-structured electronic data stored in a storage device in association with identifiers, timestamps, or metadata, enabling later retrieval and processing.

The term “storage device” refers to a hardware component or subsystem, such as a non-volatile memory unit or a magnetic storage unit, configured to store record data and other electronic information.

The term “character information” refers to digital text data composed of characters or symbols that can be processed by a computing device.

The term “natural language processing technique” refers to a set of computational methods executed by a processor to analyze and transform human language data, including operations such as tokenization, parsing, and semantic analysis.

The term “analyzable feature data” refers to machine-interpretable data derived from natural language input, including numerical vectors, tokens, tags, or other structured representations suitable for computational analysis.

The term “morphological analysis” refers to a processing operation in which words in text are decomposed into basic linguistic units, such as stems and affixes, and grammatical attributes are identified.

The term “word segmentation” refers to a processing operation that divides a character sequence into separate word units or tokens.

The term “removal of non-informative terms” refers to a processing operation that eliminates tokens such as functional words, repeated symbols, or noise characters that do not contribute meaningfully to subsequent analysis.

The term “normalization of word forms” refers to a processing operation that converts words into standard base forms, such as lemmas or canonical spellings, to reduce variation in textual data.

The term “organization value information” refers to electronic data representing principles, objectives, policies, or core values of an organization, including but not limited to vision statements and mission statements.

The term “prompt sentence” refers to a machine-generated or machine-modified textual input that instructs a generative AI model regarding analysis objectives, input context, and output format.

The term “generative AI model” refers to a computational model based on machine learning that is configured to generate text, numerical values, or structured data in response to an input, using learned parameters.

The term “degree of suitability” refers to a numerical or categorical measure indicating how well an applicant's attributes or responses align with organization value information.

The term “analysis result information” refers to electronic data output by a generative AI model, including at least a pass/fail decision, a suitability rate, and optionally explanatory text or intermediate scores.

The term “pass/fail decision” refers to a discrete evaluation outcome indicating whether an applicant satisfies or does not satisfy a predetermined selection criterion.

The term “suitability rate” refers to a numerical measure, typically represented as a percentage value, that quantifies the alignment between an applicant and organization value information.

The term “predetermined criterion” refers to a rule, threshold, or function that is defined in advance and applied to computed values, such as suitability rates, to adjust or classify those values.

The term “output data” refers to electronic data generated by a processor for transmission to a terminal, including corrected suitability rates, pass/fail information, and optionally explanatory messages.

The term “description portion” refers to a segment of a prompt sentence that contains contextual information, such as organization value information and interview result information, for presentation to a generative AI model.

The term “control portion” refers to a segment of a prompt sentence that specifies instructions to a generative AI model regarding computation tasks, output format, or constraints on generated content.

The term “evaluation viewpoint” refers to a conceptual dimension or criterion, such as cooperation or innovation, along which an applicant's suitability is individually assessed.

The term “partial suitability rate” refers to a numerical measure that represents an applicant's suitability with respect to a specific evaluation viewpoint.

The term “overall suitability rate” refers to a numerical measure that integrates partial suitability rates or other evaluation factors into a single aggregated suitability value.

In one embodiment, a server implements the claimed system as a network-accessible evaluation platform that operates in cooperation with one or more terminals used by a user such as a recruiter or evaluator. The server includes at least one processor, a main memory, a non-volatile storage device, and a network interface. The processor may be a general-purpose central processing unit, such as an x86-compatible CPU, and the server may further include one or more graphics processing units configured for accelerated matrix computation. The storage device may be a solid-state drive or another non-volatile memory device. The server executes an operating system such as a general-purpose server operating system and runs an application program implemented for example in a high-level programming language.

The terminal includes at least one processor, a display unit, an input device such as a keyboard or touch panel, a communication interface, and a memory. The terminal may be realized as a personal computer, a smart phone, a tablet device, or another client device capable of executing a web browser or a native application. The terminal communicates with the server over a communication network such as the Internet using a secure transport protocol.

The user operates the terminal to access a web-based or application-based user interface provided by the server. The user enters interview result information including applicant response information and optionally interviewer comments into a text input area displayed on the terminal. The terminal converts the interview result information into character information and generates a data structure such as a text field associated with metadata including an applicant identifier, a job role identifier, and a timestamp. The terminal transmits this data structure to the server through the network interface using a request protocol such as HTTP over a secure communication channel.

The server receives the interview result information by means of the network interface and stores the received data as record data in the storage device. The server uses a data management layer, such as a relational database management system, to maintain structured tables in which each interview record is associated with keys representing the applicant identifier and other metadata. The server thereby ensures that the interview result information is persistently stored and can be retrieved for further analysis and auditing.

The server preprocesses the character information included in the interview result information by executing a natural language processing module. The server may use software libraries such as a tokenization and part-of-speech tagging library or a syntactic parsing library. The server performs morphological analysis on the character information, dividing the text into tokens and identifying base forms and grammatical attributes of words. The server carries out word segmentation to separate contiguous character sequences into word-level units. The server removes non-informative terms such as function words, punctuation symbols, and repeated noise characters by referencing a stop-word list and applying rule-based filters. The server normalizes word forms by converting inflected forms into lemmas or canonical forms and by performing case normalization and diacritic normalization.

The server generates analyzable feature data from the preprocessed tokens. The server may compute numerical vector representations using methods such as term frequency-inverse document frequency, bag-of-words encoding, or contextual embedding. In one embodiment, the server uses a deep learning framework to obtain embeddings from a transformer-based encoder. The server applies a tokenizer associated with the encoder to map tokens into integer indices and constructs tensor structures including token identifier vectors and attention mask vectors. The server forwards these tensor structures through multiple layers of the encoder, each layer including self-attention operations and feed-forward sublayers. The encoder outputs high-dimensional embedding vectors, for example by extracting a designated representation token or by pooling token embeddings. The server stores these embedding vectors as part of the analyzable feature data.

The server also manages organization value information. The server stores organization value information as structured data in the storage device, for example, as text fields representing vision statements and mission statements, and as parameter fields representing evaluation viewpoints such as cooperation, long-term orientation, innovation, and ethical behavior. The server encodes this organization value information into vector representations, for instance, by applying the same or a compatible encoder to generate embeddings that can be compared or combined with the embeddings of the interview text.

The server constructs a prompt sentence using the analyzable feature data and the organization value information. The server generates a description portion of the prompt sentence by converting relevant parts of the interview result information and the organization value information back into human-readable text that is structured in a way that facilitates processing by a generative AI model. The server additionally generates a control portion of the prompt sentence that contains explicit instructions to the generative AI model regarding computation tasks, output format, and constraints. For example, the server may generate a prompt sentence of the following form:

“Here is the organization's vision and the applicant's interview result. Organization vision: ‘We value collaboration, long-term commitment, innovation, and ethical behavior.’

Applicant's interview result: ‘I highly value teamwork, I am always looking for new challenges, and I believe it is important to act with integrity and support my colleagues.’

Using this information, analyze how well the applicant fits the organization's vision and mission, compute a company suitability rate between 0 and 100, and decide whether the applicant should pass or fail.

Return your answer in the following format:

pass_fail: <pass or fail>

suitability_rate: <integer between 0 and 100>

reason: <brief explanation>”

The server may automatically insert evaluation viewpoints and context into the prompt sentence based on configuration data, such that the prompt sentence systematically encodes the organization value information and desired output schema. By automatically constructing the prompt sentence in this structured manner, the server constrains the behavior of the generative AI model and reduces variability and ambiguity in the model output.

The server provides the constructed prompt sentence to the generative AI model. The generative AI model may be implemented as a large-scale neural network model, such as a transformer-based language model trained on a large corpus. The server may host this model locally using a machine learning framework or may access the model through an external inference service. In the local-hosted case, the server loads model parameters into memory on the processor or a graphics processing unit. The model includes multiple attention layers and feed-forward layers, each parameterized by weight matrices and bias vectors. The server inputs tokenized representations of the prompt sentence into the model, causing the model to perform a sequence of matrix multiplications, attention weight computations, and non-linear activation operations.

The server configures the generative AI model with predetermined hyperparameters such as maximum output length, output temperature, and decoding strategy. The server may use deterministic decoding, such as greedy decoding or beam search, to obtain consistent outputs in response to the same prompt sentence. The model generates analysis result information as a sequence of output tokens. The server interprets these tokens as text and, based on the control portion of the prompt sentence, expects the output to contain a pass/fail decision, a suitability rate, and a reason field.

The server parses the analysis result information by applying text parsing algorithms. The server may use pattern-matching rules, delimiter-based parsing, or a lightweight natural language parser to extract the pass/fail decision and numerical suitability rate from the textual output. The server verifies that the suitability rate is within a valid range and that the pass/fail decision matches predefined allowable values. When necessary, the server applies error-correction routines such as reformatting numbers or stripping extraneous characters to ensure that the extracted data are usable.

The server corrects the suitability rate based on a predetermined criterion. The server may maintain normalization parameters, such as statistical averages and standard deviations computed from historical evaluation data. The server applies a normalization function that adjusts the raw suitability rate to improve comparability across different applicants and interview sessions. For example, the server may rescale the suitability rate using a linear transformation or apply a non-linear adjustment to correct known biases. The server may also combine the model's output with rule-based modifiers that enforce organization-specific thresholds, such as setting a minimum suitability rate for automatic “pass” classification. The server thereby generates a corrected suitability rate that reflects both learned patterns and deterministic correction logic.

The server generates output data for the terminal. The output data include at least the corrected suitability rate and the pass/fail decision, and may additionally include the reason text or a summary derived from the analysis result information. The server packages this output data in a data structure suitable for transmission, such as a structured response object, and sends it to the terminal via the network interface.

The terminal receives the output data and updates a graphical user interface on the display unit. The terminal renders the corrected suitability rate, for example, as a numerical value and a graphical indicator such as a bar or gauge. The terminal displays the pass/fail decision in a clearly visible area and may display or hide the reason text according to user input. The user inspects the displayed information and may store, print, or further process the evaluation results through functions provided by the terminal.

The server improves computer technology in several ways. The server reduces processing latency and memory consumption by converting unstructured interview text into analyzable feature data before invoking the generative AI model, thereby avoiding repeated handling of long raw text sequences. The use of embeddings and feature vectors allows the server to perform similarity calculations and filtering operations in vector space, which are more efficient than repeated string-level operations. The structured prompt sentence design substantially improves the predictability and parseability of the generative AI model output, reducing the need for complex post-processing and decreasing the number of failed or ambiguous inferences. By integrating normalization and correction of suitability rates within the server, the system provides machine-computable scores that can be consistently compared and aggregated, improving data management and computational efficiency.

The server further enhances accuracy and error reduction by employing a defined neural network architecture and training regime for the generative AI model. In one embodiment, the generative AI model is trained or fine-tuned using supervised examples that map interview-like input texts and organization value information to target outputs including suitability rates and pass/fail decisions. The server uses a loss function, such as a cross-entropy loss for classification components and a mean squared error loss for regression components, and updates model weights using an optimization algorithm such as stochastic gradient descent with adaptive learning rate. The server may apply data augmentation techniques to expand training data, such as paraphrasing, synonym substitution, and reordering of statements, in order to increase model robustness. By training the model in this manner, the server ensures that the internal parameters of the model are specialized for the task of structured evaluation, which contributes to improved accuracy over rule-based or purely manual methods.

The server executes non-conventional processing sequences that differ from traditional human evaluation workflows. The server does not simply emulate human judgment; instead, the server exploits vector-space representations, neural attention mechanisms, and structured prompt sentences to perform pattern recognition across large sets of historical data. The server employs rules and algorithms that are not readily executable by human evaluators, such as dynamic weighting of evaluation viewpoints based on context embeddings and multi-dimensional normalization across applicant populations. These technical measures produce effects such as improved consistency in evaluation outcomes, reduced human bias, and more efficient use of computing resources.

The server may be realized in multiple alternative embodiments. In one variation, the server executes different natural language processing pipelines tailored to different languages or domains, switching between preconfigured models based on metadata. In another variation, the server deploys a separate lightweight model for initial screening and a larger generative AI model for detailed evaluation, thereby reducing average processing time and network traffic. In still another variation, the server performs partial computation on the terminal, such as local tokenization or encryption of interview data, to reduce server workload and enhance security. All such embodiments share the technical core that the server uses analyzable feature data and structured prompt sentences to control a generative AI model and to generate corrected, machine-usable suitability evaluations.

The user therefore can employ the system in various deployment scenarios, including integration with existing recruitment platforms or internal human resource systems, while the server continues to perform the technical operations described above. The system as a whole provides a concrete technological solution that improves the way interview data are processed, analyzed, and presented by computing devices, rather than merely automating an existing human mental process.

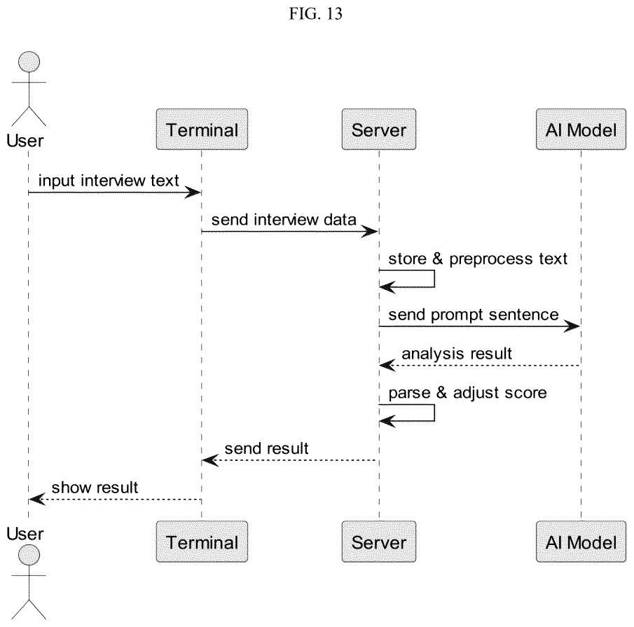

The following describes the processing flow using FIG. 13.

### Step 1

The user operates the terminal to input interview result information. The user views an input screen on the terminal and types applicant response information and, optionally, interviewer comments into a text field. The terminal receives this human-entered text as character information and associates it with metadata such as applicant ID, job role, and timestamp. As input, the terminal takes raw keystrokes or touch inputs and converts them into an internal text string stored in volatile memory. As output, the terminal generates a structured data object that includes the text string and the metadata, ready to be transmitted to the server.

### Step 2

The terminal transmits the structured data object containing the interview result information to the server. The terminal takes, as input, the text string and metadata produced in Step 1 and serializes them into a request payload, for example a structured body for an HTTP-based API call. The terminal performs data encoding and attaches communication headers, then sends the encoded payload over a communication network using a secure protocol. As output, the terminal provides a network message that is received by the server through a network interface.

### Step 3

The server receives the network message and stores the interview result information as record data in a storage device. The server takes, as input, the serialized payload received via the network interface and parses it to reconstruct the text string and metadata. The server executes a data validation routine to ensure required fields are present and text length is within allowed limits. The server then writes the validated data to a persistent data store, such as a row in a database table. As output, the server produces record data identified by a unique key, which can be accessed for subsequent processing.

### Step 4

The server preprocesses the character information in the interview result information using a natural language processing module. The server takes, as input, the raw text string from the record data and applies tokenization to split the string into tokens. The server performs morphological analysis and word segmentation, identifies parts of speech, and normalizes word forms by converting inflected terms to base forms and lowercasing characters. The server removes non-informative terms using a stop-word list and rule-based filters. As output, the server generates a cleaned token sequence and associated linguistic annotations, which constitute an intermediate representation of analyzable feature data.

### Step 5

The server converts the cleaned token sequence into numerical feature data suitable for machine computation. The server takes, as input, the tokenized and normalized text from Step 4 and applies a feature extraction method, such as vectorization or embedding. The server may compute term frequency-inverse document frequency values or feed the token sequence into an encoder model to obtain embedding vectors. The server assembles these numerical values into vector or matrix structures that can be processed by downstream models. As output, the server produces analyzable feature data representing the semantic content of the interview result information.

### Step 6

The server acquires and encodes organization value information to align it with the feature data of the interview text. The server takes, as input, stored organization value information, such as vision and mission statements and evaluation viewpoints. The server optionally applies the same or a compatible text-processing pipeline as in Steps 4 and 5, including tokenization, normalization, and embedding generation. The server then produces vector representations of the organization value information that can be compared or combined with the feature data of the applicant's text. As output, the server obtains encoded organization value data that are compatible with the interview feature data.

### Step 7

The server constructs a prompt sentence using the analyzable feature data and the organization value information. The server takes, as input, the encoded interview feature data and the encoded organization value data, and also accesses the original text forms of both. The server generates a description portion of the prompt sentence by assembling human-readable segments that describe the organization's values and summarize or quote key portions of the applicant's interview responses. The server generates a control portion of the prompt sentence that instructs a generative AI model to compute a suitability rate, output a pass/fail decision, and follow a specified output format. As output, the server produces a complete prompt sentence that encodes both context and explicit instructions.

### Step 8

The server invokes the generative AI model with the constructed prompt sentence. The server takes, as input, the textual prompt sentence from Step 7 and tokenizes it according to the vocabulary of the generative AI model. The server maps tokens to integer indices, creates attention masks, and forwards these through the neural network layers of the model. The server causes the model to perform matrix multiplications, attention calculations, and non-linear transformations over multiple layers to generate an output sequence. As output, the server obtains analysis result information in text form, including fields that describe a pass/fail decision, a suitability rate, and a reason, according to the instructions encoded in the prompt sentence.

### Step 9

The server parses and validates the analysis result information received from the generative AI model. The server takes, as input, the textual output of the model and applies parsing logic, such as pattern matching and delimiter-based extraction, to identify the portions corresponding to the pass/fail decision and the suitability rate. The server converts the suitability rate from textual form into a numerical value and checks that it falls within a valid range. The server verifies that the pass/fail decision is one of the allowed values. As output, the server produces structured evaluation data containing a raw suitability rate, a pass/fail flag, and optionally a reason string.

### Step 10

The server corrects and normalizes the suitability rate based on predetermined criteria. The server takes, as input, the raw suitability rate from Step 9 and statistical or rule-based parameters stored in the system, such as normalization coefficients or threshold values. The server applies a transformation function, which may be linear or non-linear, to adjust the raw suitability rate so that it is comparable across different interview sessions or organizational contexts. The server also applies threshold-based logic to reconcile the corrected suitability rate with the pass/fail decision, modifying the decision if necessary to match policy rules. As output, the server generates a corrected suitability rate and a finalized pass/fail decision.

### Step 11

The server generates output data for the terminal based on the finalized evaluation. The server takes, as input, the corrected suitability rate, the finalized pass/fail decision, and the optional reason string. The server constructs an output structure that includes these values and may add summary text explaining the evaluation. The server formats this structure as data suitable for network transmission and user display. As output, the server produces response data ready to be sent to the terminal.

### Step 12

The terminal receives the response data from the server and displays the evaluation results to the user. The terminal takes, as input, the response data delivered over the network and parses it to extract the corrected suitability rate, pass/fail decision, and any accompanying explanation. The terminal updates elements of the user interface, such as numerical fields, labels, and graphic indicators, to present the evaluation to the user. As output, the terminal shows a visual representation of the evaluation on the display unit, enabling the user to view the suitability rate and pass/fail result.

### Step 13

The user reviews the displayed evaluation and may initiate subsequent actions based on the results. The user takes, as input, the information presented on the terminal screen, including the corrected suitability rate, the pass/fail decision, and reasons. The user may operate controls on the terminal to store a local copy, print a report, or navigate to another screen. As output, the user's actions may cause the terminal to trigger additional processes, such as logging decisions or initiating follow-up evaluations, while the core evaluation output remains the processed data generated by the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented interview and personnel evaluation systems typically focus on simple form-based scoring or heuristic rule evaluation of candidate responses. Such systems often treat textual responses, audio streams, and image streams as isolated data sources, and either ignore emotional signals altogether or process them in an ad hoc, non-integrated manner. As a result, existing systems suffer from several technical problems.

First, known systems do not provide a unified processing pipeline in which organization objective information, job requirement information, natural-language response information, and multimodal emotion information are transformed into structured evaluation data in a consistent machine-readable format. This leads to fragmented data representations, increased memory usage, and inefficient computation when attempting to correlate candidate behavior with organization objectives.

Second, conventional systems rely heavily on static, hand-crafted question sets and pre-defined scoring rules. These approaches do not leverage the expressive capabilities of generative artificial intelligence models configured via explicit prompt sentences. Consequently, the systems are unable to dynamically generate interview questions and analysis instructions that are tailored to a particular organization objective, job role, or real-time emotional state of the candidate. This results in rigid user interfaces and limits the system's ability to adapt to evolving evaluation contexts.

Third, although some systems perform basic sentiment or tone analysis, they do not combine audio-based emotion recognition and image-based facial expression recognition into a single, time-aligned emotion representation that is fed back into the evaluation logic. Without such integrated emotion information, the system cannot accurately adjust pass/fail determinations and suitability scores in response to transient emotional states, nor can it optimize follow-up question generation in real time. This causes the evaluation to be sensitive to noise and to fail to capture deeper behavioral patterns.

Fourth, existing systems generally lack mechanisms for computing role-specific aptitude indices from past work performance information and for fusing these indices with organization suitability rates inferred from generative AI models. In the absence of such fusion, the system cannot technically infer optimized placement candidates in a scalable and automated way, leading to underutilization of computational resources and limiting objective workforce allocation.

Fifth, the architecture of conventional solutions does not formalize the construction, sequencing, and dynamic modification of multiple categories of prompt sentences (for question generation, analysis, summarization, and adaptive questioning) as first-class computational objects. This omission prevents consistent orchestration of generative AI calls and increases the complexity of integrating such models into the overall processing pipeline. Accordingly, there is a need for a computer system and server-side processing architecture that (i) systematically acquires and structures organization objective information and job requirement information, (ii) uses that structured information to build prompt sentences for a generative AI model to generate question sets and analysis outputs, (iii) integrates multimodal emotion recognition results with natural-language analysis into unified evaluation inputs, (iv) automatically computes and adjusts pass/fail determinations and organization suitability rates, (v) dynamically generates and adapts next question candidates in real time based on updated emotion information, and (vi) computes placement candidates by combining role-specific aptitude indices with organization suitability rates. Such a system should improve the technical functioning of the computer by providing more efficient data representations and processing flows, reducing manual configuration, and enabling more accurate and stable machine-generated evaluation results.

The specific processing by the specific processing unit 290 of the data processing device 12 in Application Example 2 is realized by the following means.

The present invention provides a server comprising a processor and a memory storing instructions that, when executed by the processor, cause the processor to acquire organization objective information and job requirement information and construct prompt sentences that instruct generation of questions for evaluating attributes of an evaluation target based on the organization objective information and the job requirement information, to input the prompt sentences to a generative artificial intelligence model and obtain, from the generative artificial intelligence model, a question set including questions related to the organization objective, questions for evaluating management capability, and questions for evaluating problem-solving capability, and to store the question set in association with identification information; to acquire, from a terminal device, response information, audio information, and image information of the evaluation target for at least part of the question set; to execute speech recognition processing and emotion estimation processing on the audio information, and execute expression recognition processing and emotion estimation processing on the image information, thereby generating emotion information indicating an emotional state of the evaluation target based on the audio information and the image information; to execute natural language processing on the response information to extract keyword information and semantic information, and generate structured data by associating the keyword information and the semantic information with the organization objective information; to construct an analysis prompt sentence for input to the generative artificial intelligence model by using evaluation input information including the structured data and the emotion information, input the analysis prompt sentence to the generative artificial intelligence model, and obtain an analysis result including pass/fail information and organization suitability information of the evaluation target; to calculate a pass/fail determination and an organization suitability rate of the evaluation target based on the analysis result and the emotion information, and output the pass/fail determination and the organization suitability rate to the terminal device; to construct an additional prompt sentence for the generative artificial intelligence model in response to sequential acquisition of the response information and the emotion information of the evaluation target and, based on the additional prompt sentence, generate next question candidates and intermediate evaluation results and present the next question candidates and the intermediate evaluation results to the terminal device in real time; and to acquire past work performance information, input the past work performance information to a machine learning model to calculate role-specific aptitude indices, and calculate placement candidates of the evaluation target based on the role-specific aptitude indices and the organization suitability rate. This enables the server to implement an improved computer-implemented evaluation pipeline that unifies organization objective data, natural-language response data, multimodal emotion data, generative AI outputs, and machine-learning-based aptitude indices in a structured and dynamically adaptive manner, thereby enhancing accuracy and stability of automated pass/fail determinations and suitability assessments while improving computational efficiency and reducing manual configuration effort.

The term “organization objective information” refers to information representing one or more long-term goals, visions, missions, values, or strategic directions of an organization, expressed in natural language or structured form, and stored in a computer-readable medium.

The term “job requirement information” refers to information representing one or more conditions, competencies, responsibilities, or skills associated with a role or position in an organization, expressed in natural language or structured form, and stored in a computer-readable medium.

The term “evaluation target” refers to an entity, such as an individual person or candidate, whose attributes, suitability, or aptitude are to be evaluated by the system.

The term “prompt sentence” refers to a sequence of characters or tokens in a natural language that is constructed to instruct a generative artificial intelligence model to perform a specific processing task, including but not limited to question generation, answer analysis, summarization, or adaptive questioning.

The term “generative artificial intelligence model” refers to a computer-implemented model, such as a machine learning model or neural network, that generates natural-language or structured outputs in response to input data including a prompt sentence.

The term “question set” refers to a plurality of questions generated or selected by the system, including at least questions related to organization objectives, questions for evaluating management capability, and questions for evaluating problem-solving capability, and stored in association with identification information.

The term “management capability” refers to an attribute of the evaluation target relating to planning, organizing, directing, or controlling resources or people to achieve an objective.

The term “problem-solving capability” refers to an attribute of the evaluation target relating to identifying, analyzing, and resolving issues, obstacles, or challenges in a given context.

The term “terminal device” refers to an electronic apparatus, such as a client computer, mobile device, or head-mounted display, configured to communicate with the server, present information to a user, and acquire input including response information, audio information, and image information.

The term “response information” refers to information representing an answer or reaction of the evaluation target to at least one question of the question set, the information including text data, transcribed speech data, or other natural-language content.

The term “audio information” refers to digital data representing sound, including at least spoken utterances of the evaluation target during an evaluation or interview.

The term “image information” refers to digital data representing visual content, including at least images or video frames containing a face or facial expression of the evaluation target.

The term “speech recognition processing” refers to processing that converts audio information containing speech into text data by using one or more algorithms or models.

The term “emotion estimation processing” refers to processing that analyzes features of audio information or image information to output data indicating an emotional state, such as nervousness, confidence, joy, or calmness, of the evaluation target.

The term “expression recognition processing” refers to processing that detects and analyzes facial features or facial movements in image information to infer an emotional expression or state.

The term “emotion information” refers to structured data indicating an estimated emotional state or change in emotional state of the evaluation target, derived from one or more of audio information and image information.

The term “natural language processing” refers to a series of computational operations, including but not limited to tokenization, part-of-speech tagging, syntactic parsing, semantic analysis, or keyword extraction, applied to natural-language text.

The term “keyword information” refers to one or more terms, phrases, or tokens extracted from response information that are determined to be salient for evaluation, such as domain-specific concepts, skills, or values.

The term “semantic information” refers to information representing meanings, relations, or intent inferred from response information by natural language processing, including but not limited to topic information, concept relations, and sentiment polarity.

The term “structured data” refers to data formatted into a machine-readable structure, such as a record, table, or object, in which elements including keyword information, semantic information, and organization objective information are explicitly associated.

The term “evaluation input information” refers to an information set including at least structured data and emotion information, and optionally other metadata, which is used as input content when constructing an analysis prompt sentence.

The term “analysis prompt sentence” refers to a prompt sentence constructed to instruct a generative artificial intelligence model to generate an analysis result, including at least pass/fail information and organization suitability information.

The term “analysis result” refers to output data generated by a generative artificial intelligence model in response to an analysis prompt sentence, including at least pass/fail information and organization suitability information of the evaluation target.

The term “pass/fail information” refers to information indicating whether the evaluation target satisfies or does not satisfy one or more criteria, represented for example as a binary decision, score, or classification.

The term “organization suitability information” refers to information indicating a degree of fit or alignment of the evaluation target with the organization objective information, expressed in qualitative or quantitative form.

The term “pass/fail determination” refers to a decision value calculated by the server that indicates acceptance or rejection of the evaluation target, based on at least the analysis result and emotion information.

The term “organization suitability rate” refers to a numerical value, such as a percentage or score, representing a quantified level of suitability of the evaluation target with respect to the organization objective information.

The term “additional prompt sentence” refers to a prompt sentence constructed in response to sequentially updated response information and emotion information, configured to instruct a generative artificial intelligence model to generate next question candidates or intermediate evaluation results.

The term “next question candidates” refers to one or more questions generated by a generative artificial intelligence model in response to an additional prompt sentence, intended to be asked subsequently to the evaluation target.

The term “intermediate evaluation results” refers to provisional or partial evaluation information, such as temporary scores, provisional pass/fail tendencies, or updated suitability estimates, generated during an ongoing evaluation session.

The term “past work performance information” refers to information representing historical performance of the evaluation target or other entities in one or more tasks or roles, including metrics such as productivity, quality, or error rates, stored in a computer-readable medium.

The term “machine learning model” refers to a computational model that is trained on data to learn parameters enabling prediction, classification, or estimation, including but not limited to neural networks, decision trees, and ensemble models.

The term “role-specific aptitude indices” refers to numerical values or scores output by a machine learning model that indicate predicted aptitude of the evaluation target for respective roles or job types.

The term “placement candidates” refers to one or more suggested roles, positions, or assignments for the evaluation target, calculated based on at least role-specific aptitude indices and the organization suitability rate.

The term “evaluation result summary” refers to a condensed representation of evaluation outcomes including at least response information, emotion information, pass/fail determination, organization suitability rate, and placement candidates.

The term “summarization prompt sentence” refers to a prompt sentence constructed to instruct a generative artificial intelligence model to generate evaluation result report information based on an evaluation result summary.

The term “evaluation result report information” refers to a human-readable or machine-readable report that describes evaluation outcomes, including at least pass/fail determination, organization suitability rate, key reasons, and optionally recommended placements.

The term “relaxation of tension” refers to a reduction in a level of stress, anxiety, or nervousness of the evaluation target, as inferred from emotion information.

The term “promotion of answers” refers to an effect of inducing, encouraging, or facilitating more complete, detailed, or spontaneous responses from the evaluation target, as indicated by subsequent response information.

In one embodiment, a server, a terminal, and a communication network constitute an evaluation system implementing the claimed invention. The server includes at least one processor, a main memory, a persistent storage device, and a network interface. The terminal includes at least one processor, a memory, a display device, an input device, a microphone, and a camera. The communication network includes a packet-switched network such as the Internet or an intranet.

Server executes an evaluation program stored in the memory. The evaluation program is implemented, for example, as a set of executable modules written in a general-purpose programming language and using middleware such as a database management system, a web application framework, and external machine learning libraries. In one embodiment, server uses a relational database management system as the persistent storage for organization objective information, job requirement information, past work performance information, question sets, response information, emotion information, and analysis results. Server stores organization objective information and job requirement information in normalized relational tables. For example, server stores each organization objective as one record including a unique identifier, a textual description of a vision or mission, and metadata such as creation time and validity period. Server stores each job requirement as one record including a role identifier, a textual description of main tasks, and a list of required competencies. By organizing the information into normalized tables with indexed columns, server reduces redundant storage and accelerates query operations used to construct prompt sentences.

Server uses a natural language processing framework, such as a tokenization and parsing module, to process organization objective information and job requirement information.

Server converts each textual description into a sequence of tokens and applies part-of-speech tagging and syntactic parsing. Server then constructs a vector representation of each description using a word-embedding model, such as a neural embedding model trained on domain-specific corpora, or using a sentence-embedding model. Server stores these vector representations in a separate table linked to the original texts. This pre-computation of vector representations reduces computation at evaluation time and allows efficient similarity calculation between candidate responses and organization objectives.

Server constructs a prompt sentence to be input to a generative AI model. Server assembles the prompt sentence by concatenating selected portions of the organization objective information and job requirement information, together with fixed instruction templates. For example, server constructs a prompt sentence such as:

“You are an interview question generator.

Organization vision: ‘Creating a sustainable future through innovative manufacturing.’

Target role: production supervisor.

Target competencies: management thinking, problem-solving capability, alignment with organization vision.

Generate 5 interview questions about the organization vision, 5 interview questions about management thinking, and 5 interview questions about problem-solving capability.”

Server transmits the prompt sentence via an application programming interface to a generative AI model. In one embodiment, the generative AI model is a neural language model implementing a transformer architecture including a plurality of self-attention layers, feed-forward layers, and normalization layers. Server supplies the prompt sentence as a sequence of tokens, receives the generated output tokens corresponding to interview questions, and reconstructs question texts from the tokens.

Server parses the generated output to identify question boundaries and question types. Server stores each question as a separate record including a question identifier, a question category (e.g., vision-related, management-capability-related, problem-solving-related), and the question text. By storing questions with explicit types, server can later select subsets of questions according to evaluation scenarios, thereby improving reusability and reducing the number of external calls to the generative AI model.

Terminal communicates with server to retrieve question sets and to present questions to a user. Terminal displays the questions on a graphical user interface, receives input operations from a user who acts as an interviewer, and transmits selected questions and answer timing information to server. Terminal captures voice of a candidate through the microphone and facial images of the candidate through the camera. Terminal compresses audio and image data and transmits them to server over the communication network using a secure transport protocol.

User operates terminal to start an evaluation session, to select or confirm the organization objective and job role to be used, and to initiate question presentation. User also confirms or adjusts suggested next question candidates displayed by terminal.

Server receives response information including typed text responses from terminal. When terminal does not perform local speech-to-text processing, server applies a speech recognition framework to the audio information. In one embodiment, server uses a deep neural acoustic model and a language model to transform the audio signal into a sequence of phonemes and then into words, resulting in transcribed text. Server associates the transcribed text with the corresponding question identifier and candidate identifier.

Server performs emotion estimation processing on the audio information by extracting acoustic features such as pitch, energy, spectral centroid, formant frequencies, and temporal variation statistics. Server constructs a feature vector for each defined time segment corresponding to a response. Server inputs the feature vector into a classification model, for example, a neural network comprising several fully connected layers with non-linear activation functions, trained to output an emotion label such as “nervous,” “confident,” “excited,” or “calm,” together with a confidence score. By using numerical acoustic features rather than only textual sentiment, server captures nuances in speech that are not readily apparent in text alone.

Server performs expression recognition processing on the image information by detecting faces using an image processing library and extracting facial landmark points such as eyebrow position, eye openness, and mouth curvature. Server normalizes facial landmarks to account for head pose and scale, and constructs a two-dimensional or three-dimensional feature vector. Server applies a convolutional neural network or other classifier trained on facial expression data to infer an emotion label and intensity score for each frame or set of frames. Server then aggregates frame-level emotion estimates into response-level emotion information by computing statistics such as majority label, average intensity, and temporal trend.

Server combines the audio-based and image-based emotion estimates into unified emotion information for each response. For example, server may perform a weighted combination based on modality reliability or may apply a fusion model that takes as input both acoustic and visual features. This combination reduces error rates compared to relying on a single modality, thereby improving the stability of emotion recognition.

Server executes natural language processing on the response information. Server tokenizes the transcribed text, performs part-of-speech tagging, and identifies syntactic dependencies to detect key phrases. Server extracts keyword information corresponding to technical terms, competency-related words, and organization-related terms. Server also calculates semantic information such as embeddings, topic vectors, and sentiment scores. By storing both symbolic and vectorized representations, server enables subsequent quantitative comparison between response content and organization objectives.

Server constructs structured data objects that associate, for each question, fields including question identifier, response text, keyword list, semantic vector, emotion label, and emotion intensity values. Server stores these structured data objects in the database. This structured representation simplifies subsequent data retrieval and significantly reduces the amount of ad hoc parsing required at evaluation time, thereby improving computational efficiency.

Server constructs an analysis prompt sentence using the structured data. For example, server converts key elements of the structured data into a controlled textual representation such as:

“You are an AI interviewer assistant.

Organization vision: ‘Creating a sustainable future through innovative manufacturing.’

Evaluation criteria: (1) alignment with vision, (2) management capability, (3) problem-solving capability.

For each answer, emotion data from voice and facial expressions is provided.

Question 1: [question text]

Answer 1: [response text]

Emotion during Answer 1: nervous at first, then more confident.

Question 2: [question text]

Answer 2: [response text]

Emotion during Answer 2: calm and positive.

Based on this information, output:
Pass or Fail for the candidate.
Organization suitability rate as a percentage.
A brief rationale in three bullet points.”

Server inputs the analysis prompt sentence into the generative AI model and receives an analysis result containing a pass/fail indication, a numerical organization suitability rate, and explanatory text. The generative AI model internally applies multiple transformer layers with learned parameters to model long-range dependencies between questions, answers, and emotion descriptions. This architecture allows server to capture complex patterns that would be difficult to encode in rule-based systems, such as interactions between content and emotion trajectories.

Server optionally uses an additional machine learning model trained on historical labeled evaluation data. Such a model may be a feed-forward neural network or a gradient boosting model receiving as input numerical features derived from the structured data (e.g., similarity scores between response embeddings and organization objective embeddings, counts of competency-related keywords, aggregated emotion intensities). The model outputs a predicted suitability score and a confidence interval. During training, server minimizes a loss function such as mean-squared error or cross-entropy between predicted scores and ground-truth labels, updating model weights using stochastic gradient descent or a variant thereof. Server may employ data augmentation strategies, such as paraphrasing responses or adding noise to feature vectors, to improve model generalization.

Server combines the output of the generative AI model and the additional machine learning model using a fusion algorithm, such as a weighted average of scores or a meta-learner that takes as input both scores and outputs a final decision. This combination reduces variance and improves prediction robustness. By explicitly structuring the fusion, server prevents over-reliance on any single model and thereby enhances accuracy.

Server calculates a pass/fail determination and an organization suitability rate for the evaluation target based on the analysis result and the emotion information. Server may, for example, adjust the suitability rate when emotion information indicates extreme nervousness or inconsistent emotional states, according to pre-defined numerical rules or learned adjustment functions. Server stores the final decision and rate together with associated rationale and metadata.

Server constructs an additional prompt sentence during an ongoing evaluation session. In one embodiment, server monitors newly arriving responses and emotion information and periodically generates a context summary. Server then constructs a short prompt sentence such as:

“The candidate currently appears slightly nervous but engaged.

Organization vision: ‘Creating a sustainable future through innovative manufacturing.’

So far, the candidate has emphasized teamwork and some strategic thinking.

Generate two next interview questions that will both relax the candidate and deepen assessment of their fit with the vision.”

Server inputs the additional prompt sentence into the generative AI model, receives candidate next questions, and sends them to terminal. Terminal displays the candidate questions to the interviewer user. By dynamically adapting questions based on emotion information and prior responses, server improves the information content of subsequent responses and reduces redundant or inappropriate questions, which contributes to more efficient use of computational and communication resources.

Server acquires past work performance information for evaluation targets. In one embodiment, server stores performance metrics such as production throughput, quality defect rates, task categories, error counts, and supervisor ratings in a time-series or tabular data structure. Server cleans missing values and normalizes metrics using standardization or scaling procedures. Server uses a machine learning model, such as a multi-layer perceptron or a recurrent neural network, to predict role-specific aptitude indices for multiple possible roles. During training, server uses historical placement and outcome data as labels, computes a loss function representing discrepancy between predicted and actual performance, and updates model weights.

Server computes placement candidates by combining role-specific aptitude indices with the organization suitability rate. For example, server calculates a composite score for each potential role as a weighted sum or product of the aptitude index and the organization suitability rate. Server then ranks roles by composite score and suggests top-ranked roles as placement candidates. This fused computation allows server to recommend assignments that are both aligned with organizational goals and supported by empirical performance predictions.

Server constructs a summarization prompt sentence for generating a human-readable evaluation report. For example, server constructs a prompt sentence such as:

“Summarize the candidate's interview results in a professional report including:
Final decision (Pass or Fail),
Organization Suitability Rate As a Percentage,
Main strengths and weaknesses,
Summary of emotional behavior during the interview,
Recommended placements based on role-specific aptitude indices.”

Server inputs the summarization prompt sentence and a structured summary of the evaluation data into the generative AI model, receives a text report, and stores it. Terminal retrieves the report and displays it to the user in a formatted view, or exports it to a document format.

Server, by using structured data representations, pre-computed embeddings, and modular neural network models, improves the technical functioning of the computer system. For example, by separating the extraction of structured features and the generation of prompt sentences, server reduces the length and redundancy of prompt sentences, thereby reducing the amount of data transmitted to and from the generative AI model and decreasing network load. By aggregating emotion information from multiple modalities into a compact numeric representation, server reduces storage requirements and permits faster retrieval and comparison operations. By pre-computing organization objective embeddings, server accelerates similarity calculations at evaluation time, permitting real-time interaction even when processing large numbers of candidates.

Server improves accuracy by incorporating emotion information into the evaluation pipeline in a quantitative and reproducible manner. Unlike human interviewers that may inconsistently interpret emotions, server applies fixed classifiers and loss-function-based training, which yields measurable improvements in prediction performance. Furthermore, server's fusion of multiple models and data modalities reduces both false positives and false negatives in pass/fail decisions and suitability assessments.

Server improves computational efficiency by orchestrating interactions with the generative AI model using different types of prompt sentences specifically tailored to question generation, analysis, and summarization. For instance, server can generate large question sets in batch using a single prompt sentence, while using short incremental prompts for adaptive questioning. This design reduces the number of tokens processed in each external call and thereby reduces processing latency and cost.

Terminal acts as an interface device that not only displays information but also conditions captured audio and image data. In one variation, terminal performs preliminary compression and, optionally, local noise reduction or face detection prior to transmitting data to server.

This local processing reduces bandwidth usage and ensures that server receives cleaner data for subsequent emotion recognition. In another variation, terminal performs initial speech recognition and transmits both raw audio and transcribed text, enabling server to cross-validate results and improve robustness.

User interacts with terminal to initiate evaluations, confirm organization objectives, and review evaluation results and placement suggestions. User can override or supplement automatically generated decisions, but the technical core of the invention resides in server's internal processing, data structures, and model orchestration.

In alternative embodiments, server uses different neural network architectures for emotion estimation and aptitude prediction, such as attention-based models or graph neural networks, as long as server maintains the core functionality of converting raw multimodal data into structured features and fusing them with generative AI outputs. Server may also use different optimization algorithms, such as adaptive learning rate methods, to train models. Server can be implemented as a distributed system comprising multiple physical machines or virtual instances, with individual modules (e.g., speech recognition, emotion recognition, embedding computation, generative AI interface, and placement computation) deployed as separate microservices communicating via internal APIs.

Server may also implement caching mechanisms for prompt sentences and responses. For example, when similar organization objectives and roles are repeatedly evaluated, server may reuse previously generated question sets or partial prompt templates, reducing the need to call the generative AI model. This caching leads to reduced processing time and network traffic and contributes to system scalability.

Server can be configured to operate in different domains beyond employment interviews, such as academic evaluations or customer service scenarios, as long as organization objective information and job requirement information are suitably defined. In all such embodiments, server continues to apply the same technical principles: structured representation of objectives and responses, multimodal emotion fusion, prompt-based generative AI orchestration, and machine-learning-based aptitude computation. Through these mechanisms, the invention improves the way a computer system stores, processes, and interprets evaluation data, providing technical benefits in accuracy, speed, and resource utilization that go beyond mere automation of human decision-making.

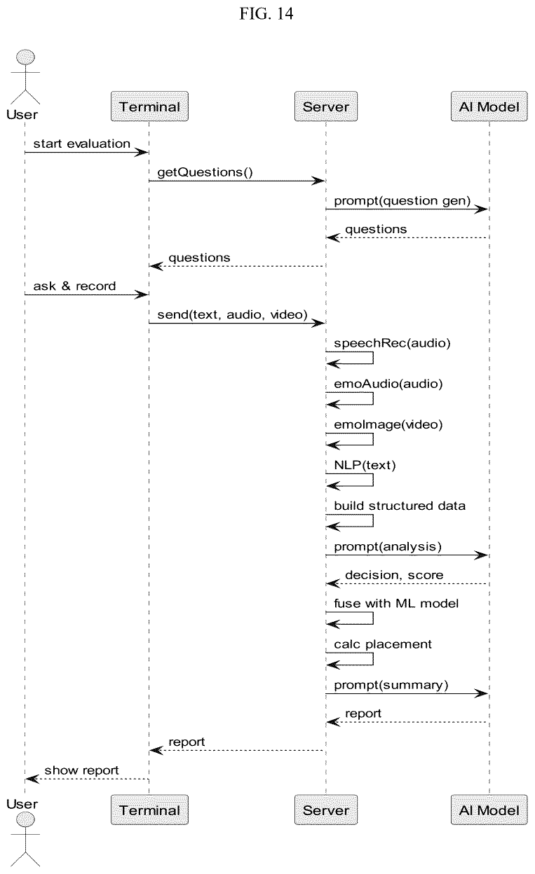

The following describes the processing flow using FIG. 14.

### Step 1

Server acquires organization objective information and job requirement information from a storage device.

Server receives as input one or more records including organization vision text, mission text, and role descriptions.

Server parses the texts using a natural language processing library to perform tokenization, part-of-speech tagging, and phrase extraction.

Server performs data processing by normalizing character encoding, removing stopwords, and identifying key phrases related to vision, values, and required competencies.

Server outputs cleaned objective text, cleaned job requirement text, and associated key phrase lists as internal data structures.

### Step 2

Server constructs a prompt sentence for question generation based on the processed organization objective information and job requirement information.

Server receives as input the cleaned texts and key phrase lists from Step 1.

Server combines fixed instruction templates with the organization vision text, the role name, and a list of target competencies (for example, management capability and problem-solving capability).

Server performs string concatenation and template substitution operations to produce a single natural language instruction.

Server outputs a prompt sentence such as:

“You are an interview question generator.

Organization vision: ‘Creating a sustainable future through innovative manufacturing.’

Target role: production supervisor.

Target competencies: management thinking, problem-solving capability, alignment with organization vision.

Generate 5 interview questions about the organization vision, 5 interview questions about management thinking, and 5 interview questions about problem-solving capability.”

### Step 3

Server sends the question-generation prompt sentence to a generative AI model and obtains a question set.

Server receives as input the prompt sentence from Step 2.

Server transmits the prompt sentence as tokenized text through an API call to the generative AI model and waits for a response.

Server processes returned tokens by decoding them into question text, splitting the text into individual questions, and classifying each question into categories such as “vision-related,” “management-capability-related,” and “problem-solving-related.”

Server outputs a structured question set in which each question record includes a question ID, category, and question text.

### Step 4

Server stores the generated question set and prepares it for delivery to terminal.

Server receives as input the structured question set from Step 3.

Server performs data insertion operations into a relational database, linking each question record to organization ID, role ID, and a question set ID.

Server may compute index values and cache the question set in memory to accelerate retrieval.

Server outputs a question set identifier and a set of database keys that terminal can use to request questions.

### Step 5

Terminal retrieves questions and displays them to a user.

Terminal receives as input the question set identifier from server.

Terminal sends a retrieval request specifying the identifier and receives question records in response.

Terminal performs data processing by ordering questions according to category or predefined priority and rendering them as text elements on a graphical user interface.

Terminal outputs displayed questions to a screen or head-mounted display for the user.

### Step 6

User operates terminal to initiate an evaluation session and to present questions to a candidate.

User receives as input the displayed question list and selects a question to ask or accepts automatic sequencing.

User initiates an evaluation by pressing a start control or issuing a voice command recognized by terminal.

User reads the question aloud to the candidate or allows terminal to display the question to the candidate.

User outputs a session start command and question selection data to terminal.

### Step 7

Terminal captures response information, audio information, and image information from the candidate.

Terminal receives as input the candidate's spoken answer, facial expressions, and any typed response.

Terminal records audio through the microphone and video through the camera, segments the recordings according to question timing, and associates each segment with a question ID.

Terminal optionally captures typed text entered in an input field and timestamps the input.

Terminal outputs audio files or streams, video frames or streams, and text responses bundled with metadata and sends them to server.

### Step 8

Server performs speech recognition processing on audio information to obtain transcribed text.

Server receives as input audio segments with associated question IDs from terminal.

Server applies a speech recognition engine that extracts acoustic features, performs acoustic modeling and language modeling, and outputs word sequences.

Server normalizes the transcribed text by lowercasing, removing extraneous silences and filler words, and aligning the text with timestamps.

Server outputs cleaned transcribed answer text and associates it with corresponding question IDs and candidate ID.

### Step 9

Server performs emotion estimation processing on audio information.

Server receives as input the same audio segments from Step 8.

Server computes acoustic features such as pitch contour, energy statistics, spectral features, and speaking rate over each segment.

Server inputs feature vectors into an emotion classification model, for example a neural network with multiple dense layers, which computes output probabilities over emotion classes such as “nervous,” “confident,” “excited,” and “calm.”

Server outputs audio-based emotion labels and confidence scores per segment.

### Step 10

Server performs expression recognition processing and emotion estimation on image information.

Server receives as input video frames or still images and associated timestamps from terminal.

Server applies a face detection algorithm to locate faces and a landmark detection module to extract points such as eyes, eyebrows, nose, and mouth corners.

Server normalizes landmark positions and feeds either normalized landmarks or cropped face regions into a convolutional neural network trained for facial expression recognition.

Server outputs image-based emotion labels and intensity scores for each time interval aligned with the candidate's responses.

### Step 11

Server fuses audio-based and image-based emotion information into unified emotion information.

Server receives as input audio-based emotion labels and scores from Step 9 and image-based emotion labels and scores from Step 10, along with time alignment data.

Server performs data processing by matching audio and image segments in time, then applying a fusion rule such as weighted averaging or a small fusion network that takes both sets of scores as input and outputs a consensus emotion.

Server outputs unified emotion information per response, including a final emotion label, an intensity measure, and a confidence value.

### Step 12

Server executes natural language processing on response information to extract keyword information and semantic information.

Server receives as input the transcribed and cleaned response text from Step 8.

Server tokenizes the text, performs part-of-speech tagging, and identifies noun phrases and verb phrases relevant to competencies and organization objectives.

Server computes text embeddings using a sentence-embedding model, calculates similarity scores between response embeddings and stored embeddings of organization objective information, and identifies high-relevance terms as keyword information.

Server outputs a set of keywords, semantic vectors, and similarity scores for each response.

### Step 13

Server generates structured data by associating response content, emotion information, and organization objective information.

Server receives as input keyword information, semantic information from Step 12, unified emotion information from Step 11, and organization objective records from Step 1.

Server constructs a structured record per response containing fields such as question ID, answer text, keyword list, semantic vector, emotion label, and emotion intensity, and a link to specific organization objective entries.

Server stores these structured records in a database table designed for efficient querying by candidate ID and session ID.

Server outputs identifiers for structured response records to be used in later analysis.

### Step 14

Server constructs an analysis prompt sentence based on structured data and emotion information.

Server receives as input structured response records and associated organization objective information from Step 13.

Server converts key fields into formatted text, summarizing each question, each answer, and corresponding emotion states, and appending evaluation criteria such as “alignment with vision,” “management capability,” and “problem-solving capability.”

Server performs string assembly operations to create a coherent instruction message for the generative AI model.

Server outputs an analysis prompt sentence such as:

“You are an AI interviewer assistant.

Organization vision: ‘Creating a sustainable future through innovative manufacturing.’

Evaluation criteria: (1) alignment with vision, (2) management capability, (3) problem-solving capability.

For each answer, emotion data from voice and facial expressions is provided.

Question 1: [text]

Answer 1: [text]

Emotion during Answer 1: nervous at first, then more confident.

Question 2: [text]

Answer 2: [text]

Emotion during Answer 2: calm and positive.

Based on this information, output:
Pass or Fail for the candidate.
Organization suitability rate as a percentage.
A brief rationale in three bullet points.”

### Step 15

Server sends the analysis prompt sentence to the generative AI model and obtains an analysis result.

Server receives as input the analysis prompt sentence from Step 14.

Server transmits the text as tokenized data to the generative AI model through an API and waits for a response.

Server decodes the response text, then parses it to extract a pass/fail indication, an organization suitability rate, and rationale text segments.

Server outputs an analysis result object containing pass/fail information, a numeric suitability rate, and rationale entries.

### Step 16

Server optionally computes an additional suitability score using a separate machine learning model and fuses it with the generative AI result.

Server receives as input structured response data from Step 13 and the analysis result from Step 15.

Server derives numerical features such as similarity scores between response and organization objective embeddings, counts of competency keywords, and aggregated emotion intensities, and feeds them into a predictive model trained on historical labels.

Server obtains a predicted suitability score from the predictive model and then applies a fusion algorithm to combine this score with the suitability rate from the generative AI model, for example by computing a weighted average.

Server outputs a fused suitability rate and an updated analysis score.

### Step 17

Server calculates a final pass/fail determination and an organization suitability rate and stores them.

Server receives as input the fused suitability rate and initial pass/fail indication from Step 16.

Server may apply threshold rules or calibration functions to adjust boundaries between pass and fail, and may adjust the suitability rate slightly based on emotion information, for example reducing the weight of extremely nervous states.

Server writes a record containing final pass/fail determination, final suitability rate, and associated rationale text into persistent storage.

Server outputs the final evaluation result for retrieval by terminal.

### Step 18

Server constructs an additional prompt sentence for adaptive questioning during an ongoing session.

Server receives as input the latest structured response records and emotion information from Step 13, along with partial evaluation results such as temporary scores.

Server summarizes the current candidate profile and emotional state into a short textual context and appends instructions to generate follow-up questions.

Server performs string concatenation to form an additional prompt sentence such as:

“The candidate currently appears slightly nervous but engaged.

Organization vision: ‘Creating a sustainable future through innovative manufacturing.’

So far, the candidate has emphasized teamwork and some strategic thinking.

Generate two next interview questions that will both relax the candidate and deepen assessment of their fit with the vision.”

Server outputs the additional prompt sentence to be sent to the generative AI model.

### Step 19

Server sends the additional prompt sentence to the generative AI model and obtains next question candidates and intermediate evaluation results.

Server receives as input the additional prompt sentence from Step 18.

Server calls the generative AI model via API, transmits the prompt sentence, and decodes the returned tokens into question text and optional intermediate evaluation comments.

Server structures the output by labeling each generated question as a “next question candidate” and extracting any interim evaluation statements.

Server outputs a set of next question candidates and intermediate evaluation results and sends them to terminal.

### Step 20

Terminal presents next question candidates and intermediate evaluation results to the user in real time.

Terminal receives as input the set of next question candidates and intermediate evaluation results from server.

Terminal updates the graphical user interface to show suggested questions and a running suitability estimate or short textual summary, without interrupting the ongoing interview.

Terminal allows user to select one of the suggested questions or to ignore them, and records the selection.

Terminal outputs the selected next question and user feedback to server for continued processing.

### Step 21

Server acquires past work performance information and calculates role-specific aptitude indices.

Server receives as input records of performance metrics associated with the evaluation target, such as production rates, quality scores, and historical role assignments.

Server preprocesses the data by handling missing values, normalizing numeric values, and encoding categorical variables.

Server feeds the processed feature vectors into a pre-trained machine learning model that outputs, for each candidate role, an aptitude score.

Server outputs a set of role-specific aptitude indices for the evaluation target.

### Step 22

Server computes placement candidates based on role-specific aptitude indices and the organization suitability rate.

Server receives as input the role-specific aptitude indices from Step 21 and the final organization suitability rate from Step 17.

Server calculates a composite score for each role by applying a combination function, such as multiplying or averaging aptitude indices and suitability rate with predefined weights.

Server sorts roles by composite score and selects top roles as placement candidates.

Server outputs a ranked list of placement candidates and stores it together with the evaluation record.

### Step 23

Server constructs a summarization prompt sentence for generating an evaluation result report and sends it to the generative AI model.

Server receives as input final evaluation results, structured data summaries, emotion summaries, and placement candidates.

Server converts these data into a concise textual input describing decision, suitability rate, main evidence, and recommended placements, and appends instructions to format the output as a professional report.

Server outputs a summarization prompt sentence such as:

“Summarize the candidate's interview results in a professional report including:
Final decision (Pass or Fail),
Organization suitability rate as a percentage,
Main strengths and weaknesses,
Summary of emotional behavior during the interview,
Recommended placements based on role-specific aptitude indices.”

Server sends this summarization prompt sentence and structured summary to the generative AI model and receives a completed report text.

### Step 24

Terminal receives and displays the evaluation result report to the user.

Terminal receives as input the report text and associated metadata from server.

Terminal formats the report for display, for example with headings, bullet points, and sections corresponding to decision, suitability rate, strengths, weaknesses, emotional summary, and placement suggestions.

Terminal presents the report on the display device and may offer options to export the report as a document file.

Terminal outputs the final visual representation of the evaluation results, enabling user to review and, if desired, store or share the results.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

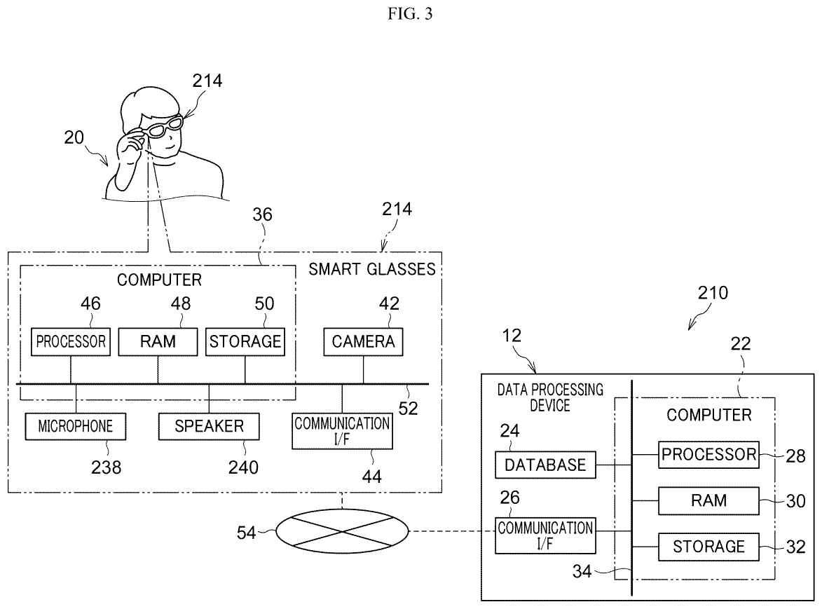

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

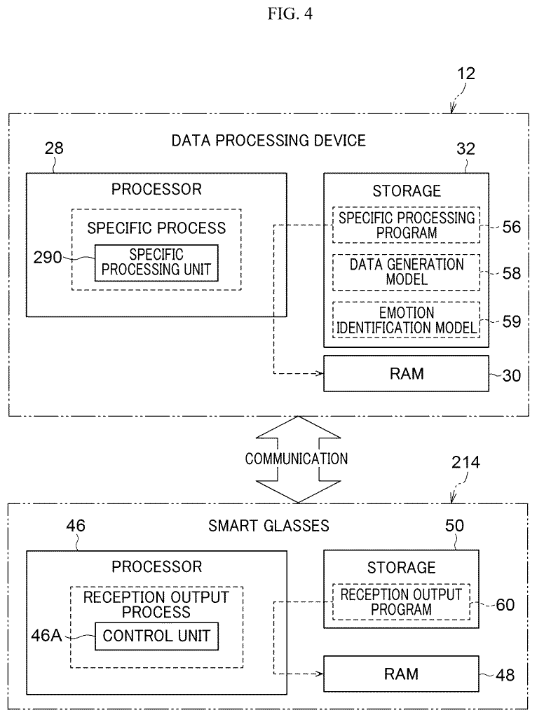

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

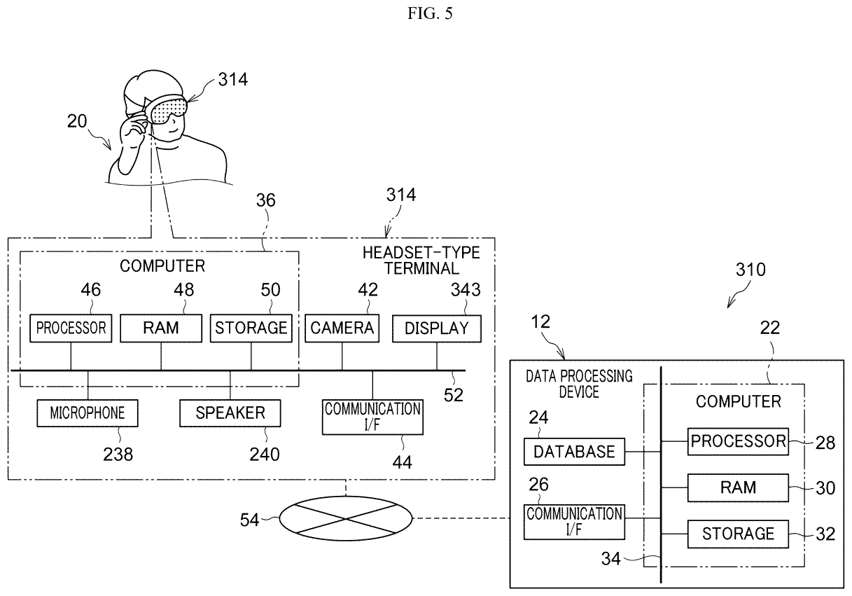

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

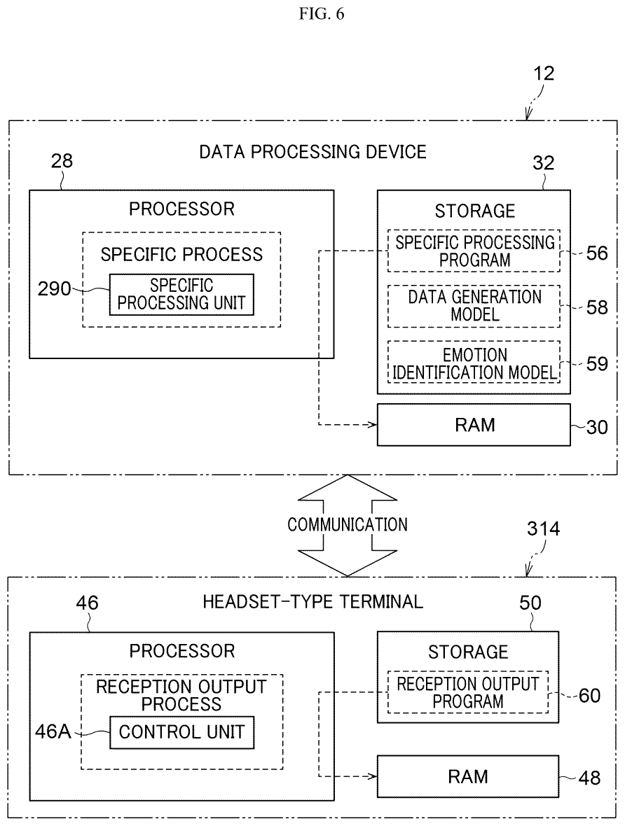

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

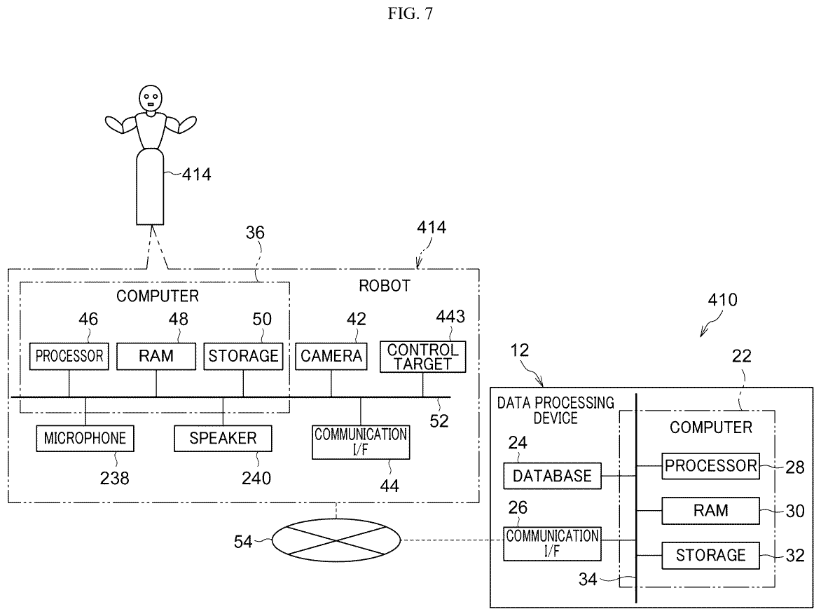

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

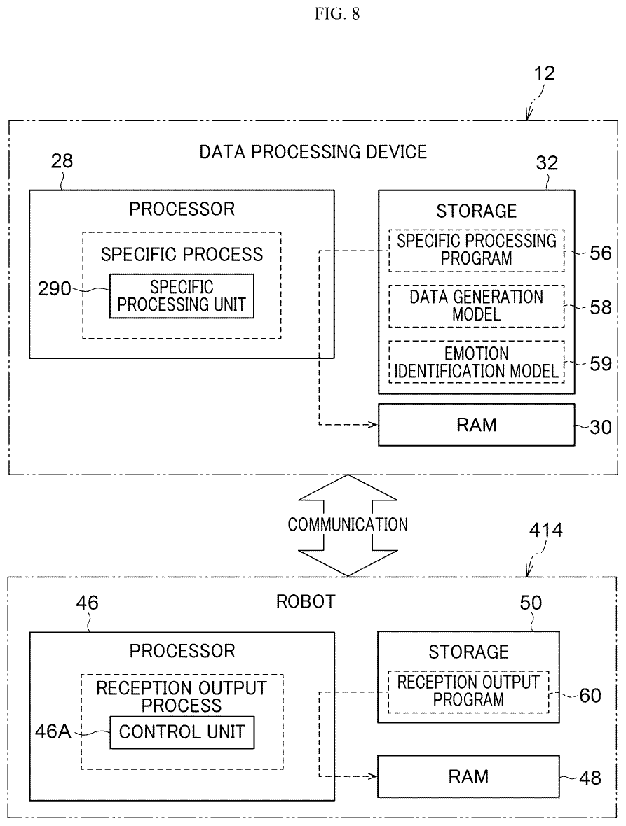

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example: an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

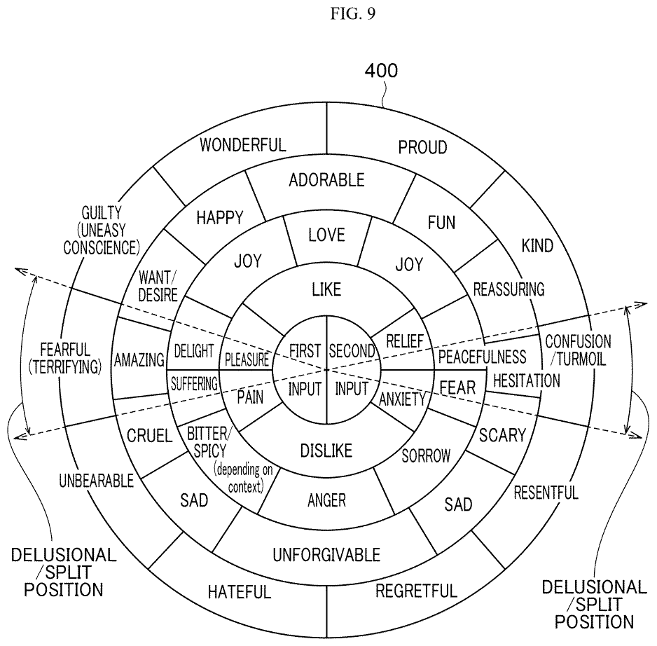

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

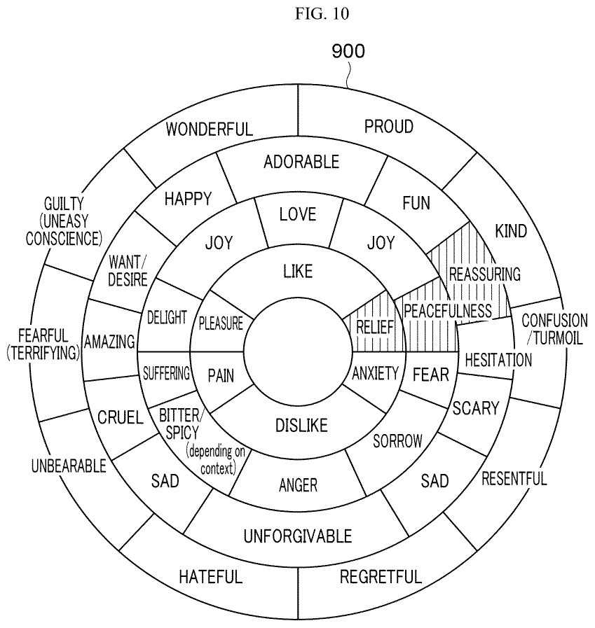

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a storage device,
wherein the processor is configured to
acquire input information including organizational goal information or job requirement information from a terminal device and store the acquired input information in the storage device,
automatically generate a prompt sentence, based on the input information stored in the storage device, the prompt sentence being configured to instruct a generative language model to generate interview questions, and including the organizational goal information or the job requirement information and evaluation target capability information,
input the automatically generated prompt sentence into the generative language model, cause the generative language model to execute natural language processing to generate a plurality of interview question sentences, and store the generated interview question sentences in the storage device,
transmit the interview question sentences stored in the storage device to the terminal device and cause the terminal device to display the interview question sentences,
acquire answer information of an interviewee from the terminal device, and, based on the acquired answer information and at least one of the organizational goal information and the evaluation target capability information, input an evaluation prompt sentence into the generative language model so as to cause the generative language model to generate an evaluation result of the answer information, and
recognize emotional state information from voice information or facial expression information of the interviewee and calculate aptitude determination information based on the evaluation result and the emotional state information.

### Supplementary 2

The system according to supplementary 1,
wherein the processor is configured to, in the automatic generation of the prompt sentence, analyze the organizational goal information and the evaluation target capability information and insert the analyzed information into a predetermined sentence template so as to generate the prompt sentence including wording that specifies a number of interview question sentences to be generated and a question format.

### Supplementary 3

The system according to supplementary 1,
wherein the processor is configured to, in generation of the evaluation prompt sentence, construct a natural language sentence including the organizational goal information, at least one of the interview question sentences, and the answer information, and include wording that instructs the generative language model to perform numerical evaluation of an organizational suitability and a capability suitability of the answer information.

### Application Example 1

### Supplementary 1

A system comprising a processor,
wherein the processor is configured to
acquire character information including a business entity vision and a business entity mission from an information terminal connected to an information processing apparatus,
create a prompt sentence, based on the character information including the business entity vision and the business entity mission, the prompt sentence instructing generation of questions for evaluating, in an interview, at least one of an executive way of thinking, a strategic way of thinking, and a problem-solving ability of a candidate,
input the prompt sentence to a generative artificial intelligence model that performs natural language processing, and cause the generative artificial intelligence model to generate a question group including questions related to the business entity vision and the business entity mission,
analyze the question group returned from the generative artificial intelligence model and format the question group as question data in a predetermined format,
transmit the formatted question data to the information terminal and cause a display unit of the information terminal to present the question data as interview questions, and
recognize an emotional state based on at least one of voice information and facial expression information of a user during an interview using the presented questions on the information terminal, and adjust a pass/fail determination and an enterprise suitability index of the candidate based on the emotional state.

### Supplementary 2

The system according to supplementary 1,
wherein the processor is configured to dynamically generate the prompt sentence based on the character information including the business entity vision and the business entity mission and control information including at least one of a number of questions, a difficulty level of the questions, and an evaluation condition indicating a target capability of the questions, and input the prompt sentence to the generative artificial intelligence model.

### Supplementary 3

The system according to supplementary 1,
wherein the processor is configured to configure the prompt sentence so as to cause the generative artificial intelligence model to generate, in addition to questions based on the business entity vision and the business entity mission, scenario-based questions for evaluating at least one of an executive way of thinking, a strategic way of thinking, business insight, and an ability to respond to a challenge.

### Example 2

### Supplementary 1

A system comprising a processor,
wherein the processor is configured to
receive interview result information including applicant response information from a terminal, and store the interview result information as record data in a storage device, and preprocess character information included in the interview result information by using a natural language processing technique, and generate analyzable feature data by performing at least morphological analysis, word segmentation, removal of non-informative terms, and normalization of word forms, and
generate a prompt sentence that uses the feature data and organization value information as inputs and instructs a generative AI model to evaluate a degree of suitability of the applicant with respect to the organization value information, and input the prompt sentence to the generative AI model to cause the generative AI model to generate analysis result information including a pass/fail decision and a suitability rate, and
extract the suitability rate and pass/fail information from the analysis result information output from the generative AI model, correct the suitability rate based on a predetermined criterion, and generate output data including a corrected suitability rate and the pass/fail information for the terminal, and
transmit the output data to the terminal and cause the terminal to display the corrected suitability rate and the pass/fail information.

### Supplementary 2

The system according to supplementary 1,
wherein the processor is configured to
generate the prompt sentence in a structure including a description portion that contains the organization value information and the interview result information of the applicant, and a control portion that instructs the generative AI model to calculate the suitability rate as a percentage and to output the pass/fail information in a predetermined format.

### Supplementary 3

The system according to supplementary 1,
wherein the processor is configured to
generate the prompt sentence in a structure that incorporates, as the organization value information, evaluation viewpoints including at least cooperation, long-term orientation, innovation, and ethical behavior, and instructs the generative AI model to calculate partial suitability rates for the respective evaluation viewpoints and an overall suitability rate.

### Application Example 2

### Supplementary 1

A system comprising a processor,
wherein the processor is configured to
acquire organization objective information and job requirement information, and construct a prompt sentence that instructs generation of questions for evaluating attributes of an evaluation target based on the organization objective information and the job requirement information,
input the prompt sentence to a generative artificial intelligence model, obtain from the generative artificial intelligence model a question set including questions related to the organization objective, questions for evaluating management capability, and questions for evaluating problem-solving capability, and store the question set in association with identification information,
acquire, from a terminal device, response information, audio information, and image information of the evaluation target for at least part of the question set,
execute speech recognition processing and emotion estimation processing on the audio information, execute expression recognition processing and emotion estimation processing on the image information, and generate emotion information indicating an emotional state of the evaluation target based on the audio information and the image information,
execute natural language processing on the response information to extract keyword information and semantic information, and generate structured data by associating the keyword information and the semantic information with the organization objective information,
construct an analysis prompt sentence for input to the generative artificial intelligence model by using evaluation input information including the structured data and the emotion information, input the analysis prompt sentence to the generative artificial intelligence model, and obtain an analysis result including pass/fail information and organization suitability information of the evaluation target,
calculate a pass/fail determination and an organization suitability rate of the evaluation target based on the analysis result and the emotion information, and output the pass/fail determination and the organization suitability rate to the terminal device,
construct an additional prompt sentence for the generative artificial intelligence model in response to sequential acquisition of the response information and the emotion information of the evaluation target, and, based on the additional prompt sentence, generate next question candidates and intermediate evaluation results and present the next question candidates and the intermediate evaluation results to the terminal device in real time, and
acquire past work performance information, input the past work performance information to a machine learning model to calculate role-specific aptitude indices, and calculate placement candidates of the evaluation target based on the role-specific aptitude indices and the organization suitability rate.

### Supplementary 2

The system according to supplementary 1,
wherein the processor is configured to construct a summarization prompt sentence for
generating an evaluation result summary including the response information of the evaluation target, the emotion information, the pass/fail determination, the organization suitability rate, and the placement candidates, input the summarization prompt sentence to the generative artificial intelligence model to generate evaluation result report information, and output the evaluation result report information to the terminal device.

### Supplementary 3

The system according to supplementary 1,
wherein the processor is configured to dynamically change at least part of the prompt sentence or the additional prompt sentence to be input to the generative artificial intelligence model based on the emotion information indicating the emotional state of the evaluation target, and cause the generative artificial intelligence model to generate questions for relaxation of tension of the evaluation target or for promotion of answers from the evaluation target.

What is claimed is:

1. A system comprising:
circuitry configured to:
receive, via a communication interface coupled to a packet-switched network, input information comprising organizational goal information or requirement information from a terminal device, and store the input information in a storage device;
generate a prompt sentence configured to instruct a generative neural network model to generate question sentences, the prompt sentence comprising the organizational goal information or the requirement information and evaluation target capability information, transmit the prompt sentence to the generative neural network model via the communication interface to cause the generative neural network model to generate a plurality of question sentences, and store the generated question sentences in the storage device;
transmit the question sentences to the terminal device via the communication interface, receive answer information from the terminal device, and generate an evaluation prompt sentence comprising the organizational goal information or the requirement information, at least one of the question sentences, and the answer information, and transmit the evaluation prompt sentence to the generative neural network model to obtain an evaluation result of the answer information; and
receive voice information or facial expression information from the terminal device via the communication interface, recognize emotional state information from the voice information or the facial expression information, and calculate aptitude determination information based on the evaluation result and the emotional state information.

2. The system according to claim 1, wherein the circuitry is configured to analyze the organizational goal information and the evaluation target capability information and insert the analyzed information into a predetermined sentence template to generate the prompt sentence, the prompt sentence specifying a number of question sentences to be generated and a question format.

3. The system according to claim 2, wherein the circuitry is configured to apply a diversity scoring function to the generated question sentences to measure a semantic distance between consecutive questions, and to regenerate the prompt sentence with an increased diversity instruction when the diversity score falls below a threshold.

4. The system according to claim 2, wherein the circuitry is configured to store a plurality of sentence templates in the storage device indexed by organizational goal category, and to select a template from the plurality based on a category classification applied to the organizational goal information prior to inserting the analyzed information.

5. The system according to claim 1, wherein the circuitry is configured to construct the evaluation prompt sentence as a natural language sentence comprising the organizational goal information, at least one of the question sentences, and the answer information, and to include an instruction that causes the generative neural network model to perform numerical evaluation of an organizational suitability score and a capability suitability score for the answer information.

6. The system according to claim 5, wherein the circuitry is configured to apply a score normalization function to the organizational suitability score and the capability suitability score, and to compute the aptitude determination information as a weighted combination of the normalized scores and the emotional state information.

7. The system according to claim 5, wherein the circuitry is configured to store the evaluation result comprising the organizational suitability score and the capability suitability score in the storage device in association with a session identifier, and to retrieve stored evaluation results for generation of a comparative analysis report transmitted to the terminal device.

8. The system according to claim 1, wherein the circuitry is configured to apply a facial expression recognition model to the facial expression information to extract a plurality of expression feature values, and to apply a voice analysis model to the voice information to extract prosodic features comprising pitch, speaking rate, and energy level, and to combine the expression feature values and the prosodic features to generate the emotional state information.

9. The system according to claim 8, wherein the circuitry is configured to apply a temporal smoothing function to the expression feature values and the prosodic features across a plurality of time frames to reduce noise in the emotional state information, and to compute an integrated emotional state classification based on the smoothed features.

10. The system according to claim 8, wherein the circuitry is configured to apply a confidence scoring function to the emotional state information, and to apply a reduced weighting factor to the emotional state information in the calculation of the aptitude determination information when the confidence score falls below a predefined threshold.

11. The system according to claim 1, wherein the circuitry is configured to apply a natural language processing function to the answer information to extract semantic content, compare the extracted semantic content against stored reference answers associated with the evaluation target capability information in the storage device, and include a semantic similarity score in the evaluation prompt sentence as an additional input parameter.

12. The system according to claim 11, wherein the circuitry is configured to compute the semantic similarity score using a vector embedding function applied to both the answer information and the reference answers, and to retrieve reference answers from the storage device using a nearest-neighbor search based on the vector embedding of the organizational goal information.

13. The system according to claim 1, wherein the circuitry is configured to transmit the question sentences to the terminal device in a sequential delivery mode, acquiring the answer information for each question sentence before transmitting a subsequent question sentence, and to dynamically select a next question sentence from the stored question sentences based on a relevance score computed from the preceding answer information and the evaluation target capability information.

14. The system according to claim 13, wherein the circuitry is configured to apply a branching function to the relevance score to select a follow-up question sentence from a secondary set of question sentences stored in the storage device when the relevance score for a primary question sentence falls below a threshold.

15. The system according to claim 1, wherein the circuitry is configured to apply a bias detection function to the evaluation result generated by the generative neural network model to identify statistically significant deviations in the evaluation scores correlated with demographic attributes extracted from the answer information, and to apply a bias correction function to the aptitude determination information when a bias is detected.

16. The system according to claim 1, wherein the circuitry is configured to aggregate aptitude determination information across a plurality of sessions stored in the storage device, compute population-level statistics for each evaluation target capability, and include the population-level statistics as a benchmark parameter in subsequent evaluation prompt sentences.

17. The system according to claim 16, wherein the circuitry is configured to apply a privacy-preserving aggregation function to the aptitude determination information prior to computing the population-level statistics, replacing individual session identifiers with anonymized tokens, and storing the aggregated statistics separately from individual session data in the storage device.

18. A system comprising:
circuitry configured to:
receive, via a communication interface coupled to a packet-switched network, input information comprising organizational goal information or requirement information and evaluation target capability information from a terminal device, store the input information in a storage device, and generate a prompt sentence comprising the organizational goal information or the requirement information and the evaluation target capability information to instruct a generative neural network model to generate a plurality of question sentences;
transmit the prompt sentence to the generative neural network model via the communication interface, store the generated question sentences in the storage device, and transmit the question sentences to the terminal device;
receive answer information from the terminal device, generate an evaluation prompt sentence comprising the organizational goal information, at least one of the question sentences, and the answer information with a numerical evaluation instruction, transmit the evaluation prompt sentence to the generative neural network model, and obtain an evaluation result comprising an organizational suitability score and a capability suitability score; and
receive voice information and facial expression information from the terminal device via the communication interface, apply a facial expression recognition model to the facial expression information and a voice analysis model to the voice information to generate emotional state information, and calculate aptitude determination information as a weighted combination of the evaluation result and the emotional state information.

19. The system according to claim 18, wherein the circuitry is configured to dynamically select a next question sentence from the stored question sentences based on a relevance score computed from preceding answer information and the evaluation target capability information, and to apply a branching function to select a follow-up question sentence from a secondary set when the relevance score falls below a threshold.

20. A method comprising:
receiving, via a communication interface coupled to a packet-switched network, input information comprising organizational goal information or requirement information from a terminal device, and storing the input information in a storage device;
generating a prompt sentence comprising the organizational goal information or the requirement information and evaluation target capability information to instruct a generative neural network model to generate question sentences, transmitting the prompt sentence to the generative neural network model via the communication interface to obtain a plurality of question sentences, and storing the question sentences in the storage device;
transmitting the question sentences to the terminal device, receiving answer information from the terminal device, generating an evaluation prompt sentence comprising the organizational goal information, at least one of the question sentences, and the answer information, transmitting the evaluation prompt sentence to the generative neural network model, and obtaining an evaluation result of the answer information; and
receiving voice information or facial expression information from the terminal device via the communication interface, recognizing emotional state information from the voice information or the facial expression information, and calculating aptitude determination information based on the evaluation result and the emotional state information.
